(19) United States
(12) Patent Application Publication
(10) Pub. No.: US 2025/0295996 A1
(43) Pub. Date: Sep. 25, 2025

(54) Systems and Methods for Physical Blocks and Corresponding Virtual Game Elements

(71) Applicant: Modern Games, Inc., Irvine, CA (US)

(72) Inventors: Justin Kifer, Irvine, CA (US); Amanda Kifer, Irvine, CA (US); Joseph Houlihan, Boulder, CO (US); Brennen Peters, Austin, TX (US); Damien Simmons, San Diego, CA (US)

(21) Appl. No.: 18/860,505

(22) PCT Filed: Apr. 27, 2023
(86) PCT No.: PCT/US2023/020170

§ 371 Date: Oct. 25, 2024

Related U.S. Application Data
(60) Provisional application No. 63/335,521, filed on Apr. 27, 2022.

(51) Int. Cl. A63F 13/56; A63F 13/26; A63F 13/79

(52) U.S. Cl. CPC A63F 13/56; A63F 13/26; A63F 13/79

(57) ABSTRACT

Provided are systems and methods for video gaming elements that engage players with gameplay elements combining physical elements and virtual elements of a gaming environment. For instance, players can collect physical blocks that are associated with digital resources such as creatures. Players can advance, battle, and/or trade their digital resources by interacting with the physical blocks in the real world. Additionally and/or alternatively, players can construct at least a portion of a virtual world based on real-world arrangements of physical blocks. Players can then interact with the virtual world they have constructed in the gaming environment.

### RELATED APPLICATIONS

This application claims priority to and the benefit of U.S. Provisional Patent Application No. 63/335,521, filed Apr. 27, 2022. U.S. Provisional Patent Application No. 63/335,521 is hereby incorporated by reference in its entirety.

### FIELD

The present disclosure relates generally to systems and methods for physical blocks and corresponding virtual game elements.

### BACKGROUND

Video gaming applications engage players with a variety of visual stimuli and activities to entertain the players. Players may earn virtual rewards such as in-game currencies or experience points (XP) in response to completing certain objectives. Games may include multiplayer elements which engage multiple players simultaneously in completing cooperative or competitive objectives. Players typically engage with video gaming applications through controllers or touchscreens, which provide limited physical stimulation.

### SUMMARY

Aspects and advantages of embodiments of the present disclosure will be set forth in part in the following description, or can be learned from the description, or can be learned through practice of the embodiments.

One example aspect is directed to a system for constructing a virtual structure based at least in part on an arrangement of a plurality of physical building blocks. The system includes: one or more processors; and one or more non-transitory, computer-readable media storing instructions that, when implemented, cause the one or more processors to perform operations. The operations include: obtaining data descriptive of a relative position of each of the plurality of physical building blocks relative to the other physical building blocks; determining, based at least in part on relative position of each of the plurality of physical building blocks relative to the other physical building blocks, data descriptive of a virtual structure layout for the virtual structure; and generating the virtual structure having the virtual structure layout.

In some implementations, the system consists of a user computing device or a server computing device, the user computing device or the server computing device comprising the one or more processors and the one or more non-transitory, computer-readable media. In some implementations, each of the physical building blocks comprises: one or more contact traces; and an internal computing module comprising computer-readable memory, the computer-readable memory configured to store one or more block attributes of the physical building block. In some implementations, for each physical building block, at least one of the one or more contact traces is in physical contact with at least one of the one or more contact traces of at least one other of the physical building blocks. In some implementations, obtaining the data descriptive of the relative position of each of the plurality of physical building blocks relative to the other physical building blocks comprises obtaining data generated via a respective communication by each of the plurality of physical building blocks via the at least one contact trace to the at least one other of the physical building blocks. In some implementations, at least one of the plurality of physical building blocks comprises a seed building block configured to aggregate communications from the plurality of building blocks to generate the data descriptive of the relative position of each of the plurality of physical building blocks relative to the other physical building blocks. In some implementations, at least one of the plurality of physical building blocks comprises a plot building block.

Another example aspect is directed to a system for constructing a virtual structure based at least in part on an arrangement of physical building blocks. The system includes one or more physical building blocks. Each physical building block of the one or more physical building blocks comprising: one or more contact traces; and an internal computing module comprising computer-readable memory, the computer-readable memory configured to store one or more block attributes of the physical building block. The system also includes a seed building block, the seed building block comprising one or more contact traces and an internal computing module. The internal computing module comprising: a communication system configured to facilitate communication with one or more external computing devices. The seed building block includes an orientation module configured to determine orientation of at least the seed building block. The seed building block includes one or more processors; and one or more non-transitory, computer-readable media storing instructions that, when implemented, cause the one or more processors to perform operations. The operations include determining, based at least in part on communication between the one or more contact traces of the seed building block and the one or more contact traces of the one or more physical building blocks, data descriptive of a virtual structure layout, the virtual structure layout being descriptive of at least one of a relative positioning, orientation, or one or more block attributes of the one or more physical building blocks; and communicating, by the communication system, the data descriptive of the virtual structure layout to the one or more external computing devices, the one or more external computing devices configured to construct a virtual structure based at least in part on the data descriptive of the virtual structure layout.

In some implementations, the one or more non-transitory, computer-readable media of the seed building block is further configured to store data descriptive of a theme of the seed building block, and wherein the operations further comprise communicating the data descriptive of the theme of the seed building block to the user computing device. In some implementations, the internal computing module of the seed building block further comprises an orientation module configured to determine the orientation of the one or more physical building blocks. In some implementations, the one or more attributes of the physical building block comprises at least one of a shape, a size, or a type of the physical building block. In some implementations, the communication system comprises a Bluetooth Low Energy (BLE) system. In some implementations, the internal computing module of the seed building block further comprises an accelerometer, and wherein the operations further comprise: determining that the seed building block has not moved for a sleep duration based at least in part on one or more signals from the accelerometer; in response to determining that the seed building block has not moved for the sleep duration, putting the internal computing module of the seed building block to sleep; and in response to one or more signals from the accelerometer, waking the seed building block from sleep. In some implementations, each physical building block of the one or more physical building blocks further comprises a coupling system. In some implementations, the coupling system comprises a magnetic coupling system. In some implementations, the coupling system comprises a protrusion and a cavity. In some implementations, the seed building block comprises a plot block having a length and a width defining a grid area. In some implementations, the length and the width of the plot block are based at least in part on a unitary dimension, and wherein the one or more physical building blocks have at least one dimension based at least in part on the unitary dimension. In some implementations, the plot block comprises one or more surface contact traces configured to receive the one or more physical building blocks. In some implementations, the plot block comprises one or more plot coupling contact traces configured to couple the plot block to a second plot block. In some implementations, the system further comprises one or more creature blocks associated with a creature resource.

Another example aspect is directed to a method for constructing a virtual structure based at least in part on a block assembly. The method includes: obtaining, by a computing system comprising one or more computing devices, data descriptive of a theme associated with a virtual structure; obtaining, by the computing system, data indicative of an orientation of the virtual structure; obtaining, by the computing system, data descriptive of a virtual structure layout based at least in part on a block assembly, the block assembly comprising one or more physical building blocks; obtaining, by the computing system, one or more virtual component resources corresponding to the one or more physical building blocks of the block assembly; and constructing, by the computing system, a virtual structure based at least in part on the virtual structure layout, the one or more virtual component resources, the theme, and the orientation of the virtual structure.

In some implementations, the data indicative of an orientation of the virtual structure is defined relative to a length and a width of a plot block of the block assembly. In some implementations, the virtual structure layout comprises one or more block attributes of the one or more physical building blocks, wherein data descriptive of the one or more block attributes is stored in computer-readable memory of the one or more physical building blocks. In some implementations, each physical building block of the one or more physical building blocks comprises one or more contact traces and an internal computing module comprising the computer-readable memory. In some implementations, the method further comprising providing one or more input systems to facilitate a player interacting with the virtual structure. In some implementations, the method further comprising rendering, by the computing system, the virtual structure.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts a block diagram of an example system for constructing a virtual structure based at least in part on an arrangement of physical building blocks according to example aspects of the present disclosure.

FIG. 2A depicts an example physical block registration according to example aspects of the present disclosure.

FIG. 2B depicts a bottom view of a physical block according to example aspects of the present disclosure.

FIG. 3 depicts a block diagram of an example physical block assembly according to example aspects of the present disclosure.

FIG. 4A depicts a block diagram of an example physical block assembly according to example aspects of the present disclosure.

FIG. 4B depicts a block diagram of an example construction of a virtual structure based at least in part on a block assembly according to example aspects of the present disclosure.

FIG. 5A depicts perspective views of an example physical building block according to example aspects of the present disclosure.

FIG. 5B depicts a top view of example physical building block according to example aspects of the present disclosure.

FIG. 5C depicts a block assembly including a first physical building block engaging with a second physical building block according to example aspects of the present disclosure.

FIG. 6A depicts example plot blocks according to example aspects of the present disclosure.

FIG. 6B depicts a top-down view of a plot block according to example aspects of the present disclosure.

FIGS. 7A-7B depict different perspectives of an example block assembly according to example aspects of the present disclosure.

FIG. 7C depicts an exploded view of an example plot block according to example aspects of the present disclosure.

FIG. 7D depicts an exploded view of an example physical building block according to example aspects of the present disclosure.

FIG. 7E depicts an exploded view of an example physical building block housing according to example aspects of the present disclosure.

FIG. 8A depicts a top-down view of an example block assembly according to example aspects of the present disclosure.

FIG. 8B depicts a perspective view of an example block assembly according to example aspects of the present disclosure.

FIG. 9A depicts a block assembly according to example aspects of the present disclosure.

FIG. 9B depicts an example virtual environment that can be constructed from the block assembly of FIG. 9A according to example aspects of the present disclosure.

FIG. 10 depicts a flow chart diagram of an example method for communicating data from a seed building block according to example embodiments of the present disclosure.

FIG. 11 depicts a flow chart diagram of an example method for constructing a virtual structure based at least in part on a block assembly according to example embodiments of the present disclosure.

### DETAILED DESCRIPTION

Generally, example aspects of the present disclosure are directed to systems and methods for video gaming elements that engage players with gameplay elements combining physical elements and virtual elements of a gaming environment. For instance, players can collect physical blocks that are associated with digital resources such as creatures. Players can advance, battle, and/or trade their digital resources by interacting with the physical blocks in the real world. Additionally and/or alternatively, players can construct at least a portion of a virtual world based on real-world arrangements of physical blocks. Players can then interact with the virtual world they have constructed in the gaming environment.

Example aspects of the present disclosure can be employed in video gaming implementations that engage players with gameplay elements in both the physical world and the gaming environment. As an example, players can purchase physical blocks that include electronics used in interacting with the gaming environment. Digital resources such as creatures, virtual structures and/or pieces thereof, etc. can be associated with the physical blocks. The players can scan the physical blocks to register and/or otherwise interact with the digital resources. Players interacting with a combination of physical blocks and virtual gameplay elements can have improved engagement and entertainment value over virtual gameplay elements alone. Additionally and/or alternatively, the gaming environment can provide a platform for multiple types of intellectual property to seamlessly interact. This can facilitate brand engagement with the gaming environment and thereby improve player engagement through branded items.

Some example aspects of the present disclosure are directed to management of digital resources. As one example, in some implementations, the digital resources can be creature resources. In some implementations, the creature resources can be representative of player-owned or player-associated instances of virtual creatures. The virtual creatures may have designs resembling animals, humanoids, machines, and/or any other suitable designs. In some cases, the virtual creatures may be based at least in part on various intellectual property such as established characters in an existing real or fictional universe. The creature resources may have one or more characteristics. The characteristics can include attributes such as “type” (e.g., an elemental type), level or experience, moves or attacks, nickname, statistics describing battle performance of the creature such as health points, attack strength, etc., genetic attributes, and/or any other suitable characteristics.

As one example, in some implementations, a player can obtain ownership of a digital resource by “scanning” or otherwise registering a physical block with an account owned by the player. As one example, the physical block can include an NFC tag, memory chip, or other suitable computer-readable media storing a unique identifier associated with the physical block, such as disposed on or within a portion, such as a bottom portion, of the physical block. The player can interface the computer-readable media (e.g., NFC tag) with a computing system by a reading device such as an NFC reader, etc. such that the computing system can read the identifier. As another example, the identifier may be a serial number printed on the block and entered by the player. The computing system can communicate with a gameplay service (e.g., on a server computing system) to register the identifier with the player's account. The player can then be awarded a digital resource corresponding to the registered physical block (e.g., the identifier). In some implementations, after successfully registering the block, the player can be presented with an animation of the digital resource “hatching” or “sprouting” from the physical block. For example, the animation can depict a virtual representation of the physical block “hatching” into a rendering of the unique digital resource the player has obtained by registering that physical block.

In some implementations, the player can purchase a physical block from a “mystery box” where the packaging and/or the physical block itself does not reveal which digital resource (e.g., creature) the player will receive from the physical block. The “mystery box” packaging may provide clues to some characteristics of the digital resource (e.g., type, element or other attributes, rarity, series or intellectual property type, etc.). As one example, icons or colors on the packaging may reveal limited information about the attribute.

In some implementations, each creature resource can have unique “genetic” characteristics related to one or more attributes of the creature resources such that creature resources of the same type can be distinguishable from each other. The genetic characteristics can be based at least in part on an identifier of the physical block associated with the creature resource, such as a serialization of an NFC tag in the physical block. In some implementations, the genetic characteristics may be uniquely assigned when the creature resource is awarded to the player. As one example, the genetic characteristics can relate to the creature's appearance. For instance, each creature resource may have minor variations in appearance from other creature resources of the same type. As another example, the genetic characteristics can relate to the creature's performance in battles. For instance, each creature may have a uniquely assigned value, multiplier, etc. relating to battle statistics such as health points, attack power, defense points, experience gain, or other statistics. As another example, the creature may have uniquely assigned moves or other attributes. In some implementations, one or more parent creature resources may be “bred” to produce a child creature resource. In some implementations, the genetic characteristics of the child creature resource can be based at least in part on the genetic characteristics of the parent creature resources. As examples, the genetic characteristics of the child creature resource may be based on averages of genetic characteristics of the parent creature resources and/or may be selected (e.g., randomly) from genetic characteristics of the parent creature resources. As another example, in some implementations, two or more creature resources can be “fused” such that the two or more creature resources receive characteristic mutation(s) based at least in part on the original genetic characteristics of each other.

In some implementations, various attribute(s) can be assigned to a physical block using procedural generation techniques. Procedural generation techniques can create data algorithmically. For example, a block and/or corresponding creature or other resource can be procedurally generated by selecting (e.g., randomly or according to a defined probability distribution) an attribute value from a set of candidate attribute values for each of a number of attributes.

According to example aspects of the present disclosure, in some implementations, ownership of the digital resources can be tracked by blockchain technology. For example, the player may be awarded, granted, or otherwise provided with a non-fungible token (NFT) associated with the digital resource in response to scanning the physical block. For instance, the player may be provided with the ability to mint the non-fungible token on a blockchain. In some implementations, the non-fungible token provided to the player can be associated at least partially with the genetic characteristics of the digital resource. As one example, the non-fungible token can represent the exact genetic makeup of the digital resource. As another example, the non-fungible token can represent the type and/or appearance (e.g., the minor variances in appearance) of the digital resource. The non-fungible token can be registered on any suitable blockchain, such as Ethereum. In some implementations, the player may select which blockchain to register the non-fungible token with.

As another example, in some implementations, the player may be provided a non-fungible token in response to completing certain gameplay objectives. As one example, the player may be awarded a non-fungible token associated with the player's creature once the creature has reached a given level (e.g., a level 100, a maximum level, etc.) or otherwise reached one of one or more checkpoints or thresholds. As another example, the player may be awarded a non-fungible token associated with the player's creature once the player scans and hatches that creature. Players can be awarded with NFTs in response to any suitable gameplay achievement in accordance with example aspects of the present disclosure.

For instance, in some implementations, each creature resource owned by the player can have an associated “level” or “experience,” or similar. In response to certain gameplay objectives such as crossing, battling, etc., the creature resource can receive experience points (XP) that increase the total experience or level of the creature resource. In some implementations, the creature resource can receive XP up to a maximum level or maximum experience. In these implementations, once the creature resource has reached the maximum level or maximum experience, it may not be awarded further experience or further experience may be converted into other virtual currencies. Additionally and/or alternatively, the player can be awarded a non-fungible token associated with the creature resource once the creature resource has reached maximum level. Further, in some implementations, there is no maximum level or maximum experience.

Example aspects of the present disclosure provide entertaining and engaging games for players that additionally improve upon so-called “play-and-earn” approach to game design, where players are rewarded with incentives separate from virtual currencies or other rewards that relate only to the gaming environment itself. Instead, the players can earn non-fungible tokens that can be exchanged for value outside of the gaming environment, such as other non-fungible tokens, cryptocurrencies, or other currencies. The game can thus present financial incentives to the player to continue playing, which can improve player engagement.

In some implementations, some or all of the physical blocks can be small and/or self-contained such that the player is able to carry the blocks around with ease. This can increase the likelihood that two players meeting in person have their respective physical blocks on their persons and are able to engage in multiplayer gameplay elements (e.g., crossing, migrating, battling, etc.). Additionally and/or alternatively, transportability of the physical blocks can facilitate the organization of gaming-centric events such as conventions, meetups, group gameplay sessions, etc., which can improve player engagement. As examples, the physical blocks can be sized such that they can fit in a player's pocket or backpack, can have batteries or otherwise be powered without wired power, can be encased in a shell, and/or have other design aspects facilitating transportability. For instance, in some implementations, the creature blocks can be small and/or self-contained. As one example, in some implementations, the creature blocks may have dimensions less than about three centimeters.

As one example, players encountering other players in person may “cross” two creature blocks. Crossing creature blocks can reward players for meeting in person, which can encourage players to carry their creature blocks on their person and to interact with other players. For instance, a player may cross creature blocks by first scanning a first creature block belonging to the player. Another player can scan a second creature block belonging to the other player. The players can then exchange their creature blocks and each player can scan the other player's creature blocks. After successfully crossing their creature blocks, the players can be awarded experience points (XP) towards the creatures associated with the crossed creature blocks, experience points associated with the players' accounts, consumables, virtual currency, and/or other rewards. Additionally and/or alternatively, in some implementations, the players can be awarded with a new creature. The new creature can be “bred” from the creatures associated with the crossed creature block. For instance, the genetic characteristics of the creatures associated with the crossed creature block can be combined to produce a new creature with the combined genetic characteristics. As one example, the bred creature can have an appearance influenced by the appearances of the parent creatures.

As another example, players meeting in person can migrate or trade two creature blocks to transfer ownership of the creature blocks from one player to another. In some implementations, to migrate creature blocks, each player scans their original creature block then exchanges their creature block with the other player. Each player then scans their new creature block and retains the new creature block. After successfully migrating their creature blocks, the players can be awarded with a new creature resource corresponding to the new creature block. In some implementations, the players may lose possession of the creature resource corresponding to their original creature block. Additionally and/or alternatively, in some implementations, the players may retain possession of the creature resource corresponding to their original creature block.

In some implementations, the player may be awarded experience points towards the new creature resource and/or the original creature resource. Additionally and/or alternatively, the player(s) (e.g., the player account(s)) can be awarded XP. In some implementations, the player can continue to earn XP from the original creature block after it has been traded to its new owner and/or from any further owners that the creature block may have. For instance, when the new owner earns XP towards the creature associated with the original creature block, the new owner may be awarded XP based at least in part on (e.g., a percentage of) the earned XP. If the creature block is again migrated to a second new owner, the original owner and/or the first new owner can receive XP when the second new owner earns XP towards the original creature block. In some implementations, the amount of XP earned by the original owner of a creature block can diminish with each subsequent new owner. For instance, the amount of XP earned from the creature block can decrease linearly, exponentially, logarithmically, and/or in any other suitable manner with each new owner of the creature block.

As another example, players can battle their creatures. For instance, players may deploy one or more creatures in battle against each other. Any suitable format for battles may be used in accordance with example aspects of the present disclosure, such as real-time battles, turn-based battles, automatic (statistics-based) battles, or any other suitable battle format. The winner of the battle can be awarded with experience points, consumables, virtual currency, and/or any other suitable rewards.

Additionally and/or alternatively, example aspects of the present disclosure are directed to systems and methods for constructing a virtual structure based at least in part on an arrangement of physical building blocks. The virtual structure can be at least a portion of a gaming environment, such as a gaming environment within a gaming application on a user computing device. For instance, the virtual structure can be a level or area of a video game, one or more structures within a larger level of a video game, and/or any other suitable type of virtual structure. In some implementations, example aspects of the present disclosure can be employed in other virtual environments (e.g., virtual design environments). As used herein, physical building blocks can correspond to any suitable game element. As one example, physical building blocks can correspond to a portion of a virtual structure that, when combined with other portions, produces a larger virtual structure resembling a building, environment, scene, etc. As another example, physical building blocks can be or can include creature blocks (e.g., to render a corresponding creature in the virtual structure), self-contained structures, earth elements, and/or any other suitable elements. Thus, the terms physical blocks and physical building blocks are used interchangeably, where a given block may be one or more of different types of blocks such as creature blocks, blocks that corresponding to a building, environment, scene, etc., and/or a seed block.

As one example, in some implementations, a larger virtual environment can include one or more “plots” of virtual space. The player can assemble one or more physical building blocks into an assembly of physical building blocks. The player and/or the gaming application can then construct one or more virtual structures in a plot of virtual space within the larger virtual environment based at least in part on the assembly of physical building blocks. In some implementations, the player and/or other players in the gaming environment can visit and/or interact with the player's virtual structure(s). The combination of physical building blocks and virtual interactivity can provide the players with both physical and mental stimulation, thereby improving player engagement and enjoyment.

In some implementations, the physical building blocks can include electronics such as NFC chips, electrodes, etc. that provide for a computing system to determine the physical arrangement of the building blocks and construct a representative virtual structure. For instance, in some implementations, each of the physical building blocks can have one or more contact traces that are configured to electrically couple with another physical building block when the blocks are in contact. In some implementations, the one or more contact traces can be at least partially located on an outward-facing surface of the physical building blocks. For instance, in some implementations, the one or more contact traces can be or can include electrical terminals (e.g., electrodes) that are placed into electrical communication with another physical building block (e.g., with the contact trace(s) of another building block) when the blocks are in contact. As one example, the contact traces can form a complete circuit and/or be in communication with one or more processors, memory devices, etc. of the physical building blocks when the blocks are in contact such that a computing system (e.g., located within one or more of the physical building blocks) can determine that the blocks are in contact and/or particular attributes of the blocks. One or more internal electrical conduits (e.g., wires, circuit board traces, etc.) can electrically couple the one or more contact traces to other (e.g., internal) components of the physical building block, such as, for example, an internal computing module, other contact traces (e.g., on other sides of the physical building block), scanners or other electronic components. For instance, in some implementations, a conductive path can be formed throughout some or all of an assembly of physical building blocks via the contact traces and/or internal electrical conduits.

Additionally and/or alternatively, each of the physical building blocks can have one or more coupling systems that are configured to couple (e.g., secure) a first physical building block to a second physical building block. Example coupling systems include, but are not limited to, magnetic coupling systems (e.g., including one or more magnets), latches, snap tabs, pins and holes, snug fit coupling systems, and/or any other suitable coupling systems and/or combination thereof. For instance, a user may place the coupling system of a first physical building block in contact with and/or proximate to the coupling system of a second physical building block. In some implementations, the user may apply force to the coupling system to cause the coupling system to couple the first physical building block to the second physical building block. For instance, the user may “snap” the first physical building block and the second physical building block together.

In some implementations, the coupling of a first physical building block to a second physical building block can place at least some of the one or more contact traces of the first physical building block into communication with the one or more contact traces of the second physical building block. For instance, in some implementations, at least a portion of the contact traces of the first physical building block can be aligned with at least a portion of the contact traces of the second physical building block when the one or more coupling systems are coupled. Other contact traces on the first and/or second physical building block can further be placed in contact with additional physical building blocks. Thus, in some implementations, a conductive path can be formed throughout some or all of an assembly of physical building blocks via the contact traces. The conductive path can provide for an internal computing module of the physical building blocks to recognize physical building blocks connected to the contact traces, and thereby determine how an assembly of physical building blocks is oriented.

In some implementations, some or all of the physical building blocks can include an internal computing module. The internal computing module can include electronics for constructing a representation of the physical building block in the virtual structure. In some implementations, the internal computing module can include one or more non-transitory computer-readable media storing data indicative of the one or more attributes of the physical building block. Additionally and/or alternatively, the internal computing module may include other components such as, for example, an NFC reader, one or more processors, etc.

Each of the physical building blocks can have one or more attributes. At least some of the attributes can relate to the physical appearance of the physical building blocks. For example, attributes can include size, shape, color, style, etc. of the physical building blocks. Data descriptive of the one or more attributes can be stored on computer-readable memory within an internal computing module of the physical building blocks. For example, the computer-readable memory can be coupled to the one or more contact traces such that the memory can be read from the one or more contact traces. The shape of the block can be any suitable shape, and is not necessarily rectangular. For instance, the shape of the block can be uniform and/or repeating or non-uniform and/or non-repeating, such as rectangular, hexagonal, triangular, spherical, etc.

The one or more attributes can be used in constructing the virtual structure from the physical building block. As examples, the one or more attributes can include a type, shape, size, color, style, etc. that have corresponding virtual appearances. For instance, in some implementations, the one or more attributes can relate to the physical appearance of the physical building block such that a portion of the virtual structure corresponding to the physical building block at least partially resembles the physical building block. Generally, the portions of the virtual structure can have more detail, be more robust, etc., than their physical block counterpart. These portions can be oriented and/or positioned in the virtual structure correspondingly to their physical arrangement, such that the virtual structure resembles the physical arrangement. The one or more attributes may not necessarily directly translate to the appearance of the virtual structure in all cases. As one example, certain combinations of physical blocks can produce an element of the virtual structure that does not resemble the physical blocks.

In some implementations, one or more of the physical building blocks used to construct the virtual structure can be a seed building block. The seed building block can act as a core of the virtual structure. At least one seed building block can provide the “brains” of an assembly of physical building blocks while the other physical building blocks are relatively simpler, including lesser electronic components than the seed building block. Thus, the seed building block may be a more intelligent block, which, in some cases, can provide for reduced cost of other physical building blocks. For instance, in some implementations, the other physical building blocks can have relatively simple and/or cost-effective internal computing modules. For instance, in some implementations, the seed building block can include a more advanced internal computing module than that of some other physical building blocks, such as an internal computing module including hardware configured to facilitate communications with other computing systems, hardware configured to determine attributes of connected physical building blocks (e.g., number, orientation, type, etc.), battery system(s), etc.

In some implementations, the seed building block can have a communication system. The communication system can be configured to communicate with a gaming application on a player's computing system, such as a gaming console, a personal computer, a virtual reality (VR) system, tablet computer, smartphone, and/or any other suitable computing system. The communication system can be wired and/or wireless. As one example, the communication system can be or can include a Bluetooth Low-Energy (BLE) system. As another example, the communication system can be or can include a universal serial bus (USB) connector and/or adapter. The communication system can be or can include any suitable communication technologies.

In some implementations, the seed building block can include a power system. In some implementations, the power system can include one or more batteries. The one or more batteries can be disposable and/or rechargeable batteries. For instance, in some implementations, the seed building block can include one or more rechargeable batteries and/or a charging port. The charging port can be coupled to the rechargeable batteries and/or can supply power to the batteries. In some implementations, the charging port can be a universal serial bus (USB) port, such as a USB type A port, a Micro USB port, a USB type C port, etc. In some implementations, the charging port can additionally be used for wired communications with a computing system. Additionally and/or alternatively, in some implementations, the power system can include one or more capacitors. In some implementations, the power system can be charged wirelessly.

In some implementations, the seed building block can power down when not in use to conserve power. For instance, in some implementations, the seed building block can include an accelerometer or other device to wake up the seed building block after powering down. As one example, the internal computing module of the seed building block can be configured to perform operations including determining that the seed building block has not moved for a sleep duration based at least in part on one or more signals from the accelerometer. For instance, the seed building block can be configured to power down after the sleep duration has elapsed without being moved. The sleep duration can be any suitable duration, such as time, clock cycles, etc. The operations can include, in response to determining that the seed building block has not moved for the sleep duration, putting the internal computing module of the seed building block to sleep. For instance, the internal computing module can be placed into a low-power-consumption “sleep” state, such as a state with limited computational activity. The operations can include, in response to one or more signals from the accelerometer, waking the seed building block from sleep. For instance, when the one or more signals form the accelerometer indicate that the seed building block has been moved, the block can be returned to a normal computational mode.

In some implementations, the seed building block can have an associated theme. For instance, the theme may be associated with a particular environment (e.g., forest, desert, space, urban, etc.), a particular intellectual property, a particular element, a particular architectural style, etc. The theme can control the appearance of a structure built using the seed building block. For example, if a player builds a structure with a forest themed seed building block, the virtual structure (including other building blocks) can be rendered with a forest theme in which textures, models, resources, etc. may resemble or depict forests. Attributes of the other building blocks (e.g., shape, size, type, etc.) can control the arrangement of the virtual structure while the theme can control the appearance of the virtual structure, textures used in rendering the virtual structure, music and/or sound effects that play in proximity to the virtual structure, characters or environmental effects that appear around the virtual structure, and/or other aesthetic effects of the virtual structure.

In some implementations, a particular physical building block can have an associated theme. For instance, the theme can be stored in a memory of an internal computing module of the physical building block. The theme of the physical building block can be used in rendering the physical building block. As one example, instead of the seed building block having an associated theme, some or all physical building blocks can have an associated theme used in constructing the virtual structure. As another example, a theme of a physical building block, when present, can override the theme of the seed building block for the portion of the virtual structure corresponding to that physical building block. Remaining physical building blocks (e.g., blocks without an associated theme) can then be constructed with the theme of the seed building block. Furthermore, in some implementations, a theme of the seed building block must match a theme of a physical building block for the seed building block to be used in constructing a virtual structure with the seed building block.

In some implementations, the seed building block can communicate with the gaming application such that the gaming application can determine the theme of the seed building block. As one example, the gaming application can read data indicative of the theme of the seed building block from the communication system of the seed building block. For instance, as one example, the data indicative of the theme of the seed building block can be a theme identifier uniquely associated with the theme of the seed building block. The gaming application can have one or more virtual resources (e.g., textures, etc.) associated with the theme identifier, such as referenceable based at least in part on the theme identifier. The gaming application can then render the virtual structure based at least in part on the virtual resources associated with the theme identifier. As another example, the seed building block itself can store virtual resources (e.g., textures, etc.) used in constructing the virtual structure with the theme of the seed building block.

In some implementations, the seed building block can be a plot block. The plot block can resemble a substantially two-dimensional “plot” for building physical structures, which can resemble, for example, a mat, baseplate, etc. The plot block can be configured to receive one or more physical building blocks. In some implementations, the plot block can be configured in a “grid” configuration having a length and/or a width defining a grid area. The length and/or the width can be defined based at least in part on a number of physical building blocks that can be disposed along the length and/or the width. For instance, in some implementations, the physical building blocks can be “tiles” having a unitary length, width, and height. For example, the physical building blocks may have unitary dimensions such as “1 by 1” or “1 by 2” referring to discrete units, such that, for example, two 1 by 1 blocks placed end-to-end occupies a substantially similar space to a 1 by 2 block. The plot block can additionally and/or alternatively be dimensioned according to a similar or same unitary dimension such that the plot block can receive a discrete number of dimensional units' worth of physical building blocks. As examples, the plot block can have unitary length and width such as 3 by 3, 6 by 6, 12 by 12, etc. For instance, a 3 by 3 plot block can receive nine 1 by 1 physical building blocks, and/or an equivalent total of blocks having larger dimensions than 1 by 1. Although the unitary dimension may correspond to a measurement unit, such as an inch, centimeter, etc., the unitary dimension can be any suitable size in accordance with example aspects of the present disclosure.

Some example aspects of the present disclosure are directed to systems and methods for constructing a virtual structure from physical building blocks. The systems and methods can be used with any suitable computing system, such as a computing system including one or more computing devices, one or more processors, etc. For instance, some or all of the operations discussed herein can be performed by an internal computing module (e.g., one or more processors thereof) of a physical building block, such as a seed building block. Additionally and/or alternatively, some or all of the operations discussed herein can be performed by a computing system, user computing device, or other suitable computing structure, such as a gaming application implemented by one or more processors.

A player can arrange one or more physical building blocks to form a block assembly of one or more physical building blocks. For instance, the player can couple the coupling systems of each of the one or more physical building blocks together such that the physical building blocks are arranged into the block assembly. Additionally and/or alternatively, the contact traces of (e.g., adjacent) physical building blocks in the block assembly can be placed into contact to form electrically conductive paths through at least a portion of the block assembly. The block assembly can include at least one seed building block.

Systems and methods according to example aspects of the present disclosure can include communicating, by a computing system, data descriptive of a theme of the virtual structure. As an example, a seed building block (e.g., an internal computing module of the seed building block) can communicate the data descriptive of theme of the virtual structure to a gaming application. For instance, in some implementations, data descriptive of the theme of the virtual structure can be stored by non-transitory, computer-readable media of the seed building block (e.g., the internal computing module of the seed building block). As another example, in some implementations, the theme of the virtual structure can be determined based at least in part on one or more attributes of the seed building block, such as an identifier of the seed building As one example, the identifier could be included in a Bluetooth attribute that is broadcast by a Bluetooth communications module. The Bluetooth module can be preprogrammed (e.g., factory-programmed) to broadcast the identifier attribute. block, serial number of the seed building block, model number of the seed building block, etc. The systems and methods according to example aspects of the present disclosure can include obtaining, by a computing system (e.g., by a gaming application on a user computing device), data descriptive of a theme associated with the virtual structure. The data descriptive of the theme can be, for example, a theme identifier.

In some implementations, the computing system can be configured to determine an assembly orientation of the block assembly of physical building blocks. For instance, in some implementations, the seed building block (e.g., an internal computing module of the seed building block) can determine the assembly orientation of the block assembly. The assembly orientation of the block assembly can be used in determining the orientation of the virtual structure. For instance, the assembly orientation can be defined relative to a “ground” plane, a coordinate grid (e.g., a three-dimensional coordinate grid), and/or any other suitable reference. The virtual structure can then be oriented such that the direction of the reference of the assembly orientation corresponds to a direction of virtual ground or other suitable virtual reference.

For example, in some implementations, the seed building block can be a plot block having a length and a width. The orientation of the virtual structure can be defined such that the plot block acts as the ground plane (e.g., the length and width are in the direction of the ground plane). As another example, in some implementations, the seed building block and/or another physical building block can include an orientation module. The orientation module can be or can include any suitable device for determining orientation of the seed building block and/or other physical building block(s) such as, for example, a gyroscope. The orientation module can determine how the assembly is oriented relative to a reference such as, for example, earth gravity. It should be understood that ground plane does not necessarily need to resemble surface-level ground, but can resemble other environments such as the sky, space, ocean, underground, etc.

In some implementations, systems and methods according to example aspects of the present disclosure can include communicating, by a computing system (e.g., by an internal computing module of a seed building block), data indicative of an orientation of the virtual structure. In some implementations, systems and methods according to example aspects of the present disclosure can include receiving, by a computing system (e.g., by a gaming application on a user computing device), data indicative of an orientation of the virtual structure.

Systems and methods according to example aspects of the present disclosure can include determining, by a computing system (e.g., a user computing device and/or an internal computing module of a seed building block), a virtual structure layout based at least in part on the physical building blocks. The virtual structure layout can be or can include data descriptive of an arrangement of at least one seed building block and one or more physical building blocks. For instance, the virtual structure layout can be a schematic or arrangement of a virtual structure to be rendered by a gaming application. The virtual structure layout can be descriptive of at least one of a relative positioning, orientation, or one or more attributes of the assembly of physical building blocks. Additionally and/or alternatively, in some implementations, the virtual structure layout can include the data indicative of the theme of the seed building block.

Systems and methods according to example aspects of the present disclosure can be configured to communicate the data descriptive of the virtual structure layout to a user computing device. As one example, the internal computing module of the seed building block can communicate the data descriptive of the virtual structure layout to a gaming application on the user computing device. The user computing device can be configured to construct a virtual structure based at least in part on the data descriptive of the virtual structure layout. For instance, a gaming application on the user computing device can construct and/or render the virtual structure.

A computing system can obtain data descriptive of the virtual structure layout. Additionally and/or alternatively, the computing system can obtain one or more virtual structure component resources. The one or more virtual structure component resources can be associated with virtual representations based at least in part on the physical building blocks. As one example, the one or more virtual structure component resources can be associated with a same shape, size, type, or other characteristics as corresponding physical building blocks. For instance, in some cases, the virtual structure component resources can have an appearance that is similar to an appearance of a corresponding physical building block. In some implementations, the virtual structure component resources can be digital resources, such as, for example, virtual models of or resembling the physical building blocks.

Based at least in part on the data descriptive of the virtual structure layout, the assembly orientation, the theme, the one or more virtual structure component resources, and/or other data descriptive of the block assembly, the computing system can construct a virtual structure corresponding to the block assembly. For example, the computing system can arrange the virtual structure component resources as illustrated by the virtual structure layout such that the layout of the virtual structure component resources in the virtual structure corresponds to the layout of the physical building blocks in the block assembly.

In some implementations, aspects of the virtual structure layout and/or the virtual structure can be procedurally generated. For example, attributes of the virtual structure such as a texture or visual appearance can selected randomly or from a defined probability distribution (e.g., a probability distribution that is a function of attribute(s) of one or more corresponding physical blocks).

Turning now to the FIGS., example aspects of the present disclosure will be discussed in detail. It should be understood that various aspects depicted in the FIGS. can be combined, modified, rearranged, and/or omitted without departing from the scope or spirit of the present disclosure.

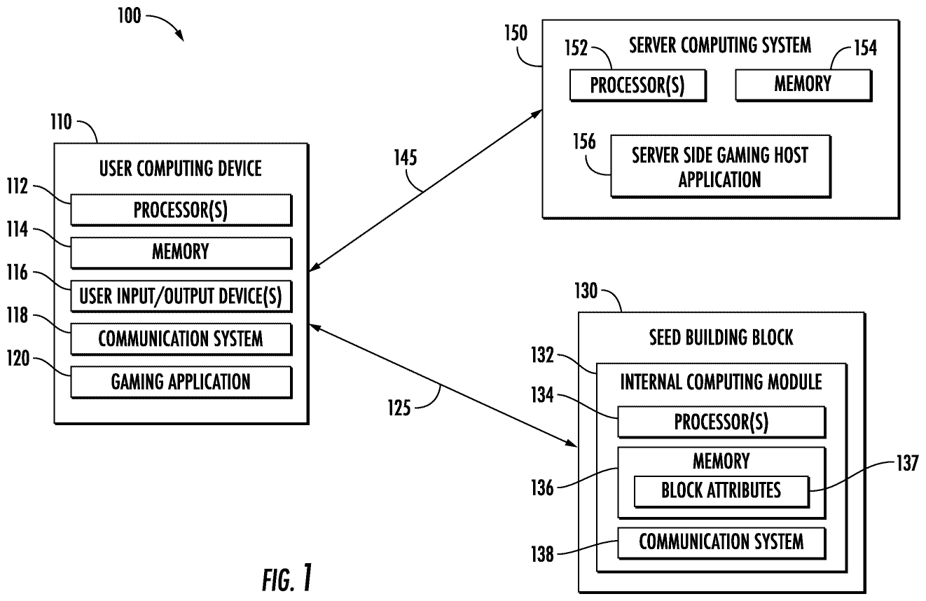

FIG. 1 depicts a block diagram of an example system 100 for constructing a virtual structure based at least in part on an arrangement of physical building blocks according to example aspects of the present disclosure. A user computing device 110 can be configured to run a gaming application 120. For instance, the gaming application 120 can be pre-installed on the device, installed via an application distribution service or virtual store, downloaded from the internet, etc. User computing device 110 can be or can include any suitable computing device(s) such as, for example, a personal computer, a laptop computer, a desktop computer, a gaming console, a mobile phone (e.g., a smartphone), a tablet computer, and/or any other suitable computing device(s).

The gaming application 120 can utilize components of the user computing device, such as processor(s) 112, computer-readable memory 114, user input and/or output device(s) 116, and/or communication system 118, to provide for a user of the user computing device 110 to interact with a gaming environment of the gaming application 120. As examples, the user input and/or output device(s) 116 can include components used to facilitate user control and/or interaction with the user computing device 110, such as, for example, a keyboard, a computer mouse, a display screen, a touch-sensitive surface (e.g., a touch screen), audio systems such as speakers, headphones, subwoofers, etc., a microphone, a gaming controller and/or components thereof (e.g., a joystick, button(s), gyroscope, etc.), and/or any other suitable components.

The user computing device 110 can communicate with server computing system 150 over network 145. Network 145 can be or can include any suitable wired and/or wireless network and/or portion thereof, such as an IEEE 802.11 network, Wi-Fi network, LAN, Ethernet, etc. The server computing system 150 can be configured to run (e.g., by processor(s) 152 and/or computer-readable memory 154) a server-side gaming host application 156. The server-side gaming host application 156 can facilitate networked features of the gaming application 120. Example networked features can include, but are not limited to, player account management, authentication, and synchronization, data management and synchronization, server-side local data backup, multiplayer interactions such as creature resource crossing, battling, migrating, etc., hosting and/or sharing of player's constructed virtual structures, management of a persistent online virtual world, etc., and/or any other suitable networked features. For example, in some implementations, players can construct virtual structures according to example aspects of the present disclosure on gaming application 120. Gaming application 120 can be in communication with server-side gaming host application 156. Gaming application 120 can share constructed virtual structures and/or other gaming data with the host application 156, which can additionally and/or alternatively facilitate a gaming environment among multiple players on other user computing devices. In some implementations, at least some portions of the gaming application 120 can be executed on user computing device 110 without connecting to server-side gaming host application 156.

Additionally and/or alternatively, the user computing device 110 can communicate (e.g., by communication system 118) with seed building block 130. Seed building block 130 can act as a core of a larger block assembly of physical building blocks. The block assembly can be coupled to seed building block 130 according to example aspects of the present disclosure. In this way, the seed building block 130 can communicate information related to the block assembly (e.g., arrangement, type, etc. of blocks) to user computing device 110 and/or gaming application 120.

In particular, the seed building block 130 can include internal computing module 132 to facilitate computing-related functionality of seed building block 130. The internal computing module 132 can include one or more processor(s) 134 and/or computer-readable memory 136. The computer-readable memory 136 can store data descriptive of one or more block attributes 137. The block attributes can be or can include attributes of the seed building block 130 such as, for example, a theme of the seed building block 130, a size of the seed building block 130, etc. Additionally and/or alternatively, the internal computing module 132 can include communication system 138 to facilitate communication with user computing device 110, such as with communication system 118 and/or gaming application 120 of user computing device 110. The seed building block 130 can communicate with user computing device 110 over connection 125. The connection 125 can be or can include any suitable wired and/or wireless connection suitable for facilitating data transmission. Examples of connection 125 include, but are not limited to, a Bluetooth connection, Bluetooth Low Energy (BLE) connection, ZigBee connection, Wi-Fi connection, universal serial bus (USB) connection, proprietary connections, etc. As one example, communication system(s) 118 and/or 138 can be BLE communication modules configured to establish a BLE connection between seed building block 130 and user computing device 110.

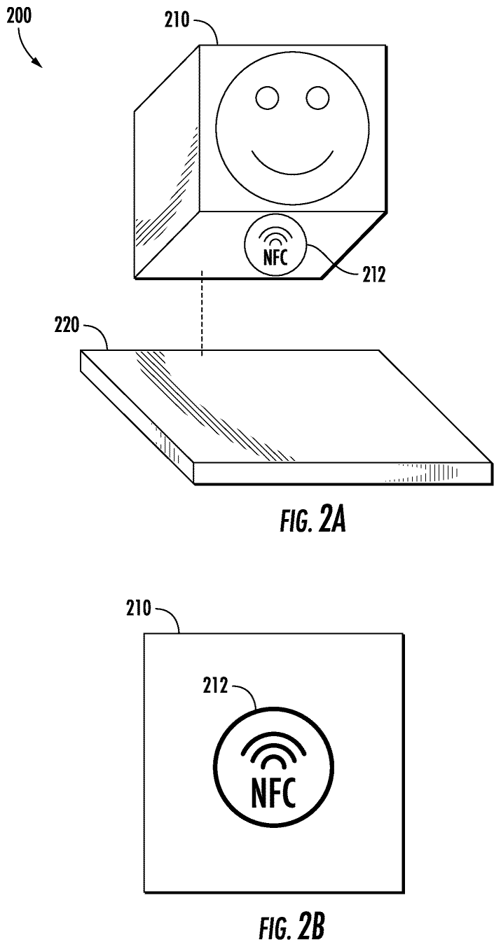

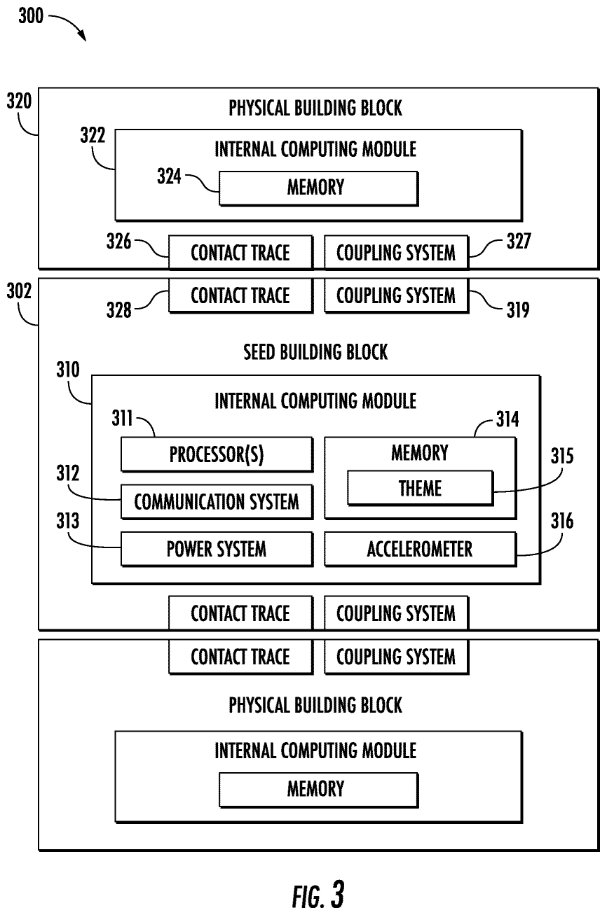

FIG. 2A depicts an example physical block registration 200 according to example aspects of the present disclosure. FIG. 2B depicts a bottom view of a physical block 210 according to example aspects of the present disclosure. Physical block 210 can include a near-field communication (NFC) tag 212 disposed on and/or within physical block 210. Additionally and/or alternatively, physical block 210 can be printed, formed, or otherwise designed to resemble a creature resource associated with the physical block 210. As one example, computer-readable memory on or within the physical block 210 (e.g., the NFC tag 212) can store data descriptive of the creature resource associated with the physical block 210. As another example, a computing system can identify and/or generate the creature resource associated with the physical block 210 based at least in part on the physical block 210, such as based at least in part on an identifier of the NFC tag 212 of physical block 210. A player can purchase physical block 210 and subsequently interface physical block 210 and/or NFC tag 212 with an NFC reader 220. NFC reader 220 can be a standalone NFC reader and/or incorporated into a larger computing system (e.g., a player's smartphone, personal computer, etc.). The NFC reader 220 can read data from the NFC tag 212 when the physical block 210 is interfaced with the NFC reader 220. As an example, the NFC reader 220 can read data such as an identifier of the NFC tag, one or more block attributes (e.g., creature type, etc.), and/or any other suitable data.

After a player has scanned the physical block 210, a computing system coupled to NFC reader 220 can perform various functions associated with a gaming application. As one example, the computing system can register a creature resource associated with physical block 210 with a player's account. For instance, in some implementations, the computing system can generate a creature resource associated with the data read from the NFC tag 212 of physical block 210, such as a creature resource associated with an identifier of the NFC tag 212 and/or physical block 210. Additionally and/or alternatively, in some implementations, the computing system can write data descriptive of the creature resource to the physical block 210.

As another example, the computing system can “cross” the physical block 210 with another. For instance, players encountering other players in person may “cross” two creature blocks. Crossing creature blocks can reward players for meeting in person, which can encourage players to carry their creature blocks on their person and to interact with other players. For instance, a player may cross creature blocks by first scanning, with NFC scanner 220 (e.g., with the NFC scanner 220 on the player's own device), a first creature block (e.g., block 210) belonging to the player. Another player can scan a second creature block belonging to the other player. The players can then exchange their creature blocks and each player can scan the other player's creature blocks. After successfully crossing their creature blocks, the players can be awarded experience points (XP) towards the creatures associated with the crossed creature blocks, experience points associated with the players' accounts, consumables, virtual currency, and/or other rewards. Additionally and/or alternatively, in some implementations, the players can be awarded with a new creature. The new creature can be “bred” from the creatures associated with the crossed creature block. For instance, the genetic characteristics of the creatures associated with the crossed creature block can be combined to produce a new creature with the combined genetic characteristics. As one example, the bred creature can have an appearance influenced by the appearances of the parent creatures.

As another example, the computing system can migrate the creature resource associated with physical block 210. players meeting in person can migrate or trade two creature blocks to transfer ownership of the creature blocks from one player to another. To migrate creature blocks, each player scans (e.g., with NFC reader 220) their original creature block, then exchanges their creature block with the other player. Each player then scans their new creature block and retains the new creature block. After successfully migrating their creature blocks, the players can be awarded with a new creature resource corresponding to the new creature block. In some implementations, the players may lose possession of the creature resource corresponding to their original creature block. Additionally and/or alternatively, in some implementations, the players may retain possession of the creature resource corresponding to their original creature block. In some implementations, the player may be awarded experience points (XP) towards the new creature resource and/or the original creature resource.

As another example, the computing system can battle a creature resource associated with physical block 210. Players can battle their creatures. For instance, players may deploy one or more creatures in battle against each other. Any suitable format for battles may be used in accordance with example aspects of the present disclosure, such as real-time battles, turn-based battles, automatic (statistics-based) battles, or any other suitable battle format. The winner of the battle can be awarded with experience points (XP), consumables, virtual currency, and/or any other suitable rewards.

FIG. 3 depicts a block diagram of an example physical block assembly 300 according to example aspects of the present disclosure. Block assembly 300 includes seed building block 302 and one or more physical building blocks 320. Two physical building blocks 320 are depicted in FIG. 3 for the purpose of illustration. It should be understood that any suitable number of physical building blocks 320 can be coupled to seed building block 302 and/or other physical building blocks 320.

The seed building block 302 and/or each of the physical building blocks 320 can have one or more contact traces 318, 326 that are configured to electrically couple with contact traces 318, 326 of another physical building block 320 when the blocks are in contact. In some implementations, the one or more contact traces can be at least partially located on an outward-facing surface of the physical building blocks 320. For instance, in some implementations, the one or more contact traces 318, 326 can be or can include electrical terminals that are placed into electrical communication with another physical building block 320 (e.g., with the contact traces 318, 326 of another building block) when the blocks 320 are in contact. As one example, the contact traces 318, 326 can form a complete circuit and/or be in communication with one or more processors, memory devices, etc. of the physical building blocks 320 when the blocks 320 are in contact such that a computing system (e.g., located within one or more of the physical building blocks 320) can determine that the blocks 320 are in contact and/or particular attributes of the blocks 320. One or more internal electrical conduits (e.g., wires, circuit board traces, etc.) can electrically couple the one or more contact traces 318, 326 to other (e.g., internal) components of the physical building block 320, such as, for example, an internal computing module 310, 322, other contact traces 318, 326 (e.g., on other sides of the physical building block 320), scanners or other electronic components. For instance, in some implementations, a conductive path can be formed throughout some or all of an assembly of physical building blocks 320 via the contact traces 318, 326 and/or internal electrical conduits. As another example, in some implementations, the internal computing modules 310, 322 can communicate by wireless communication (e.g., by a BLE module).

Additionally and/or alternatively, the seed building block 302 and/or each of the physical building blocks 320 can have one or more coupling systems 319, 327 that are configured to couple (e.g., secure) a first physical building block to a second physical building block. Example coupling systems 319, 327 include, but are not limited to, magnetic coupling systems (e.g., including one or more magnets), latches, snap tabs, pins and holes, snug fit coupling systems, and/or any other suitable coupling systems and/or combination thereof. For instance, a user may place the coupling system of a first physical building block in contact with and/or proximate to the coupling system of a second physical building block. In some implementations, the user may apply force to the coupling system 319, 327 to cause the coupling system 319, 327 to couple the first physical building block to the second physical building block. For instance, the user may “snap” the first physical building block and the second physical building block together. As an example, as depicted in FIG. 3, coupling system 319 is coupling seed building block 302 to coupling system 327 of physical building block 320.

The seed building block 302 can act as a core of the virtual structure. At least one seed building block 302 can provide the “brains” of block assembly 300. Seed building block 302 can include internal computing module 310. Internal computing module 310 can include components for facilitating electronic features of block assembly 300. Internal computing module 310 can include, for example, one or more processor(s) 311. The processor(s) 311 can be configured to perform operations for communicating with a gaming application, operations for determining a virtual structure layout of block assembly 300, and/or other suitable operations.

Additionally and/or alternatively, the internal computing module 310 can include a communication system 312 to facilitate communications with a user computing device and/or a gaming application. The communication system 312 can be configured to communicate with a gaming application on a player's computing system, such as a gaming console, a personal computer, a virtual reality (VR) system, tablet computing system, smartphone, and/or any other suitable computing system. The communication system 312 can be wired and/or wireless. As one example, the communication system 312 can be or can include a Bluetooth Low-Energy (BLE) system. As another example, the communication system 312 can be or can include a universal serial bus (USB) connector and/or adapter.

In some implementations, the seed building block 302 can include a power system 313. In some implementations, the power system 313 can one or more batteries. The one or more batteries can be disposable and/or rechargeable batteries. For instance, in some implementations, the seed building block 302 can include one or more rechargeable batteries 313 and/or a charging port. The charging port can be coupled to the rechargeable batteries 313 and/or can supply power to the batteries 313. In some implementations, the charging port can be a universal serial bus (USB) port, such as a USB type A port, a Micro USB port, a USB type C port, etc. In some implementations, the charging port can additionally be used for wired communications with a computing system (e.g., as at least a portion of communication system 312). Additionally and/or alternatively, in some implementations, the power system 313 can include one or more capacitors. In some implementations, the power system 313 can be charged wirelessly.

In some implementations, the seed building block 302 can power down when not in use to conserve power. For instance, in some implementations, the seed building block 302 can include an accelerometer 316 or other device to wake up the seed building block 302 after powering down. As one example, the internal computing module 310 of the seed building block 302 can be configured to perform operations including determining that the seed building block 302 has not moved for a sleep duration based at least in part on one or more signals from the accelerometer 316. For instance, the seed building block 302 can be configured to power down after the sleep duration has elapsed without being moved. The sleep duration can be any suitable duration, such as time, clock cycles, etc. The operations can include, in response to determining that the seed building block 302 has not moved for the sleep duration, putting the internal computing module 310 of the seed building block 302 to sleep. For instance, the internal computing module 310 can be placed into a low-power-consumption “sleep” state, such as a state with limited computational activity. The operations can include, in response to one or more signals from the accelerometer 316, waking the seed building block 302 from sleep. For instance, when the one or more signals form the accelerometer 316 indicate that the seed building block 302 has been moved, the block can be returned to a normal computational mode.

Additionally and/or alternatively, the internal computing module 310 can include computer-readable memory 314. The memory 314 can store data descriptive of a theme 315 associated with the seed building block 302. For instance, the theme 315 may be associated with a particular environment (e.g., forest, desert, space, urban, etc.), a particular intellectual property, a particular element, a particular architectural style, etc. The theme 315 can control the appearance of a virtual structure built from block assembly 300 using the seed building block 302. For example, if a player builds a structure with a forest themed seed building block 302, the virtual structure (including other building blocks) can be rendered with a forest theme in which textures, models, resources, etc. may resemble or depict forests. Attributes of the other building blocks (e.g., shape, size, type, etc.) can control the arrangement of the virtual structure while the theme 315 can control the aesthetic appearance of the virtual structure, textures used in rendering the virtual structure, music and/or sound effects that play in proximity to the virtual structure, characters or environmental effects that appear around the virtual structure, and/or other aesthetic effects of the virtual structure.

The physical building blocks 320 can be relatively simpler, including lesser electronic components than the seed building block 302. Thus, the seed building block 302 may be a more intelligent block, which, in some cases, can provide for reduced cost of other physical building blocks 320. For instance, in some implementations, the physical building blocks 320 can have relatively simple and/or cost-effective internal computing modules 322. For instance, in some implementations, the seed building block 302 can include a more advanced internal computing module 310 than that of some other physical building blocks. The internal computing module 322 can include computer-readable memory 324. The computer-readable memory can store data descriptive of one or more attributes of the physical building blocks 320. For example, the computer-readable memory 324 can be coupled to the one or more contact traces 326 such that the memory 324 can be read from the one or more contact traces 326. At least some of the attributes can relate to the physical appearance of the physical building blocks 320. For example, attributes can include size, shape, color, style, etc. of the physical building blocks 320.

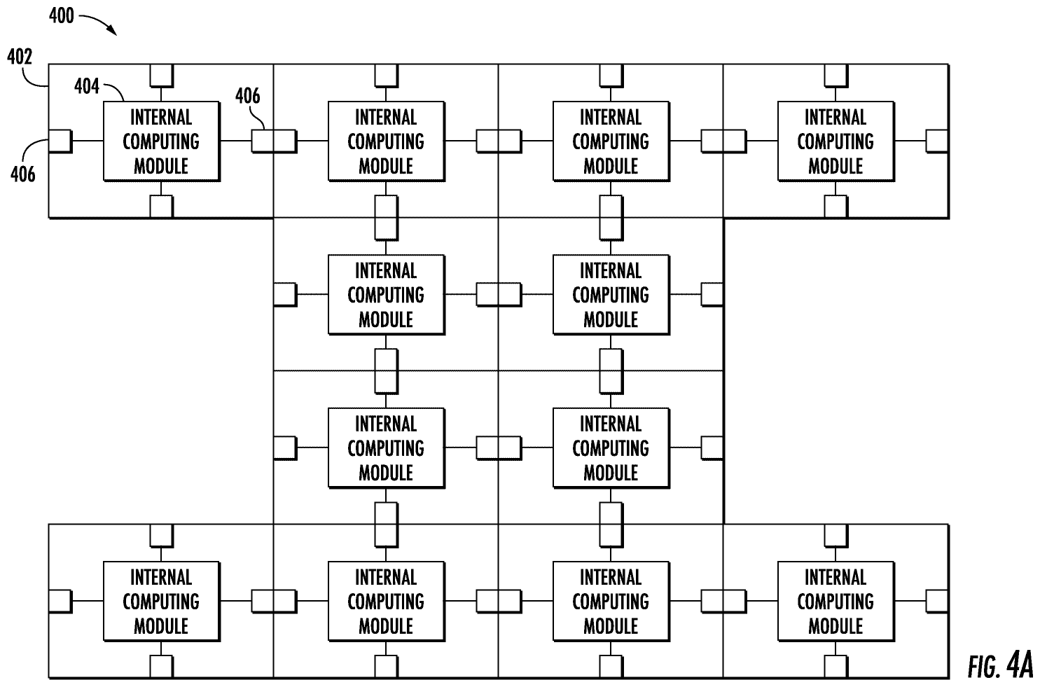

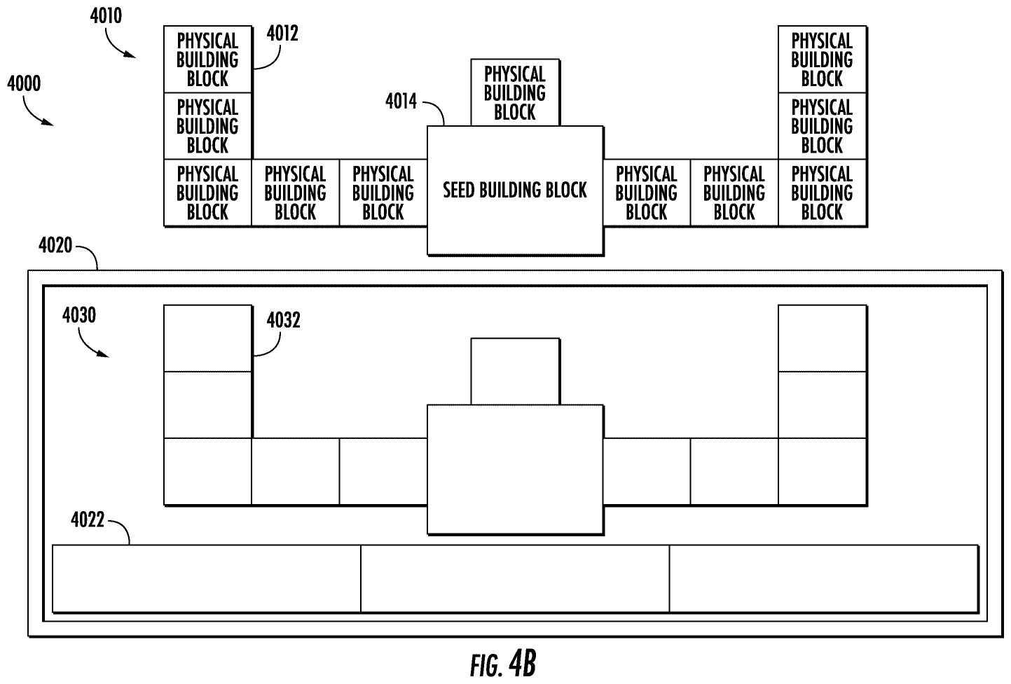

FIG. 4A depicts a block diagram of an example physical block assembly 400 according to example aspects of the present disclosure. The block assembly 400 can include a plurality of physical building blocks 402. One or more of the physical building blocks 402 can be a seed building block. Each of the blocks 402 can include a respective internal computing module 404. The internal computing modules 404 can be or can include at least a computer-readable memory storing block attributes. The internal computing modules 404 can be coupled to those of neighboring blocks 402 by contact traces 406.

For instance, the coupling of a first physical building block 402 to a second physical building block 402 can place at least some of the one or more contact traces 406 of the first physical building block 402 into communication with the one or more contact traces 406 of the second physical building block 402. For instance, in some implementations, at least a portion of the contact traces 406 of the first physical building block 402 can be aligned with at least a portion of the contact traces 406 of the second physical building block 402 when the one or more coupling systems are coupled. Other contact traces 406 on the first and/or second physical building block 402 can further be placed in contact with additional physical building blocks 402. Thus, in some implementations, a conductive path can be formed throughout some or all of an assembly of physical building blocks 402 via the contact traces 406. The conductive path can provide for an internal computing module 404 of the physical building blocks 402 (e.g., of a seed building block) to recognize physical building blocks 402 connected to the contact traces, and thereby determine how an assembly of physical building blocks 402 is oriented. The block assembly 400 can thus be formed of a plurality of physical building blocks 402 and a virtual structure resembling the block assembly 400 can be constructed.

FIG. 4B depicts a block diagram 4000 of an example construction of a virtual structure 4030 based at least in part on a block assembly 4010 according to example aspects of the present disclosure. As illustrated, block assembly 4010 can include one or more physical building blocks 4012 and/or a seed building block 4014. A user computing device 4020 can run a gaming application configured to communicate with the seed building block 4014. The seed building block 4014 and/or the gaming application can determine the arrangement and/or orientation of the block assembly 4014 according to example aspects of the present disclosure. The user computing device 4020 can then construct virtual structure 4032 resembling the block assembly 4010. In some implementations, a player can be provided with input systems 4022 to interact with the virtual structure 4032. The input systems 4022 can provide for the player to control a virtual avatar to navigate the virtual structure 4032, deploy creatures within the virtual structure 4032, modify the virtual structure 4032, and/or any of a variety of gameplay features. For instance, players can interact with virtual structures built by other players in a persistent virtual environment. Additionally and/or alternatively, the player may deconstruct the assembly of physical building blocks without affecting the virtual structure. For instance, the player may disassemble the block assembly so the player can build additional structures with their physical building blocks. In some implementations, the player can publish new virtual structures, such as by overwriting an older virtual structure.

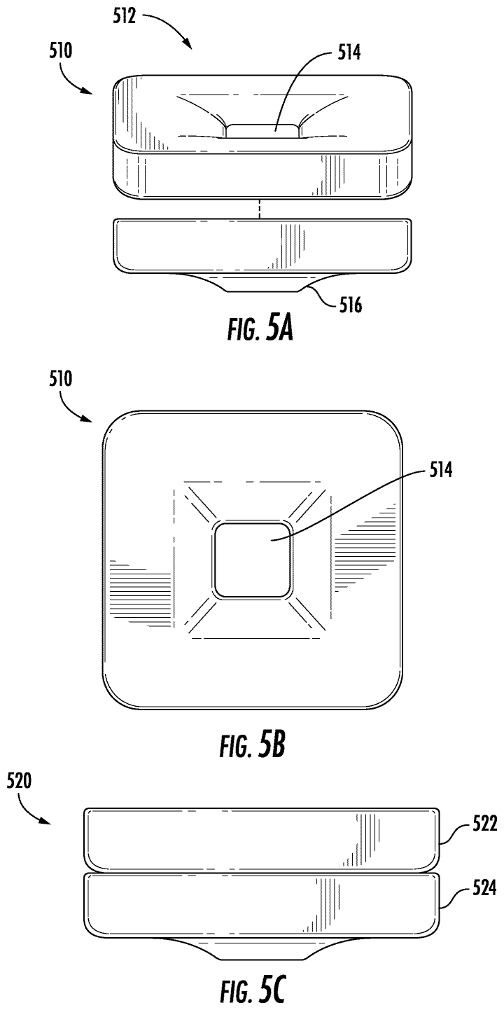

FIG. 5A depicts perspective views of an example physical building block 510 according to example aspects of the present disclosure. FIG. 5B depicts a top view of example physical building block 510 according to example aspects of the present disclosure. FIG. 5A depicts one example embodiment of a physical building block 510. It should be understood that other physical building blocks can be employed according to example aspects of the present disclosure.

Physical building block 510 includes a coupling system configured to couple one physical building block 510 to another. The coupling system includes a cavity 512 on one surface of the physical building block 510 Disposed on an opposite surface from the cavity 512 is a protrusion 516. It should be understood that protrusion 516 can be disposed on a non-opposite surface from a cavity 512 in accordance with the present disclosure. The cavity 512 is configured to receive a protrusion 516 of another physical building block 510. The cavity 512 and the protrusion 516 can thus engage to couple the physical building blocks 510 together in a secure manner. For instance, FIG. 5C depicts a block assembly 520 including a first physical building block 522 engaging with a second physical building block 524.

In some implementations, the cavity 512 and/or protrusion 516 can include magnet 514. The magnet 514 of a first physical building block 522 can be configured to engage a magnet 514 and/or other magnetic surface (e.g., a piece of metal) of a second physical building block 524 when the protrusion 516 of the second block 524 is inserted into cavity 512 of the first block 522. The magnets 514 can serve to reinforce the coupling of the blocks 510. Additionally and/or alternatively, the magnets 514 can be the contact terminals. In some implementations, the magnets 514 can be painted a same color as an exterior shell of the physical building block 510.

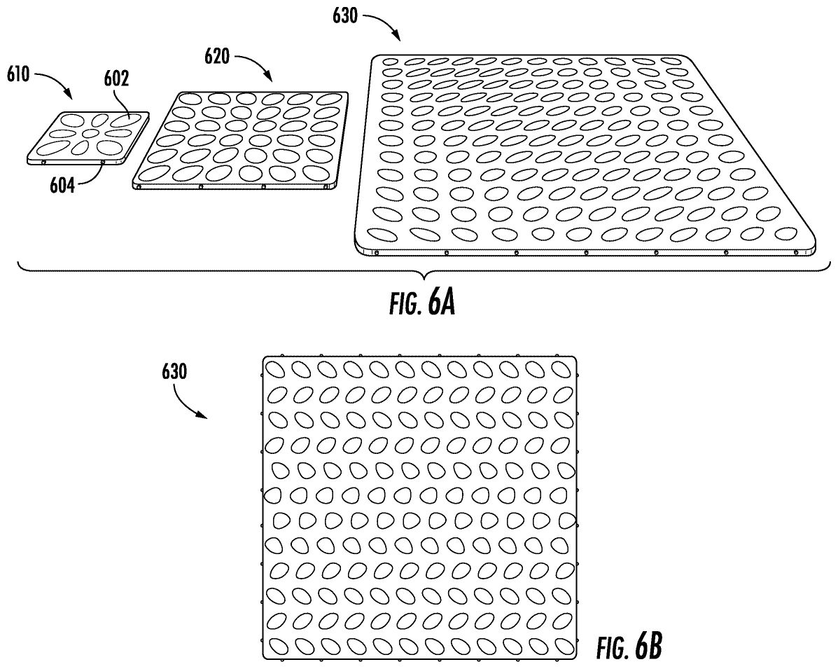

FIG. 6A depicts example plot blocks 610, 620, 630 according to example aspects of the present disclosure. The plot blocks 610, 620, 630 can be seed building blocks. The plot blocks 610, 620, 630 can be configured to receive one or more tile blocks, such as the block 510 of FIG. 5. For instance, the plot blocks 610, 620, 630 can each include one or more surface contact traces 602 configured to receive tile blocks. The surface contact traces 602 can be disposed on a top surface of the plot blocks 610, 620, 630. For instance, FIG. 6B depicts a top-down view of a plot block according to example aspects of the present disclosure.

The block 510 depicted in FIGS. 5A-5B can be a 1 by 1 tile block, configured to occupy one surface contact trace 602. The plot block 610 can be a 3 by 3 plot block providing a space of three units by three units for receiving tile blocks. For instance, the plot block 610 can have nine total surface contact traces 602. Similarly, the plot block 620 can be a 6 by 6 plot block having 36 surface contact traces 602 and/or the plot block 630 can be a 12 by 12 plot block having 144 surface contact traces 602. Other sizes of plot blocks can be used in accordance with example aspects of the present disclosure. Additionally and/or alternatively, in some implementations, each space of the plot blocks 610, 620, 630 can have a cavity in place of the surface contact trace 602.

Additionally and/or alternatively, in some implementations, the plot blocks 610, 620, 630 can include one or more plot coupling contact traces 604. The plot coupling contact traces 604 can be disposed on a side surface of the plot blocks 610, 620, 630. The plot coupling contact traces can facilitate expansion of a player's building surface by providing for the player to couple two or more plot blocks 610, 620, 630 together to form a contiguous building surface. For example, a player can couple two 6 by 6 plot blocks 620 together to produce a total surface of 12 by 6 units. In some implementations, the surface contact traces 602 and/or the plot coupling contact traces 604 can be or can include magnets.

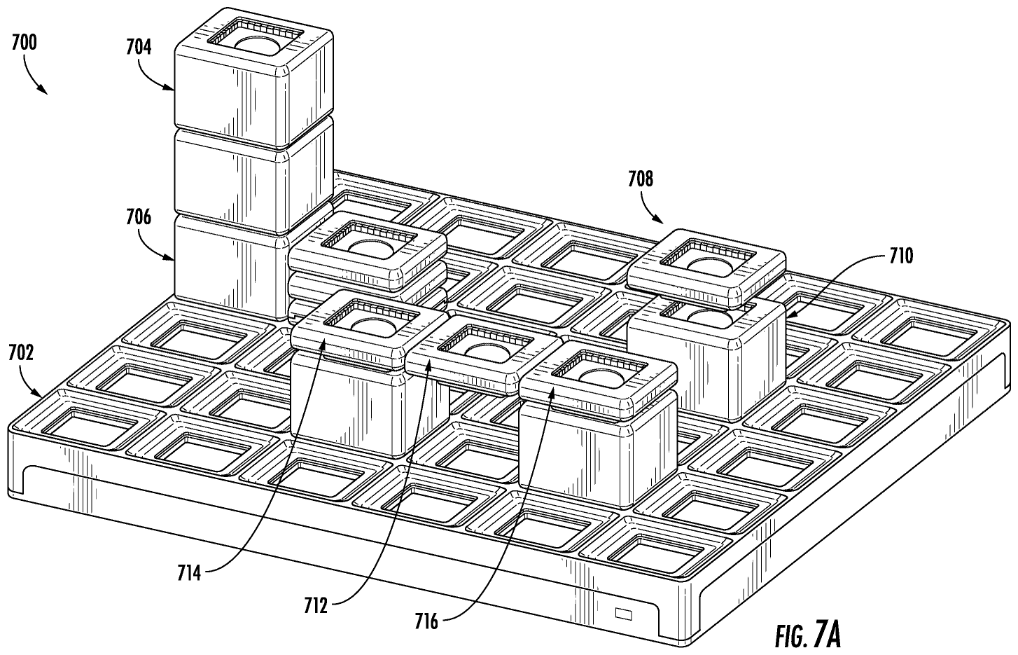

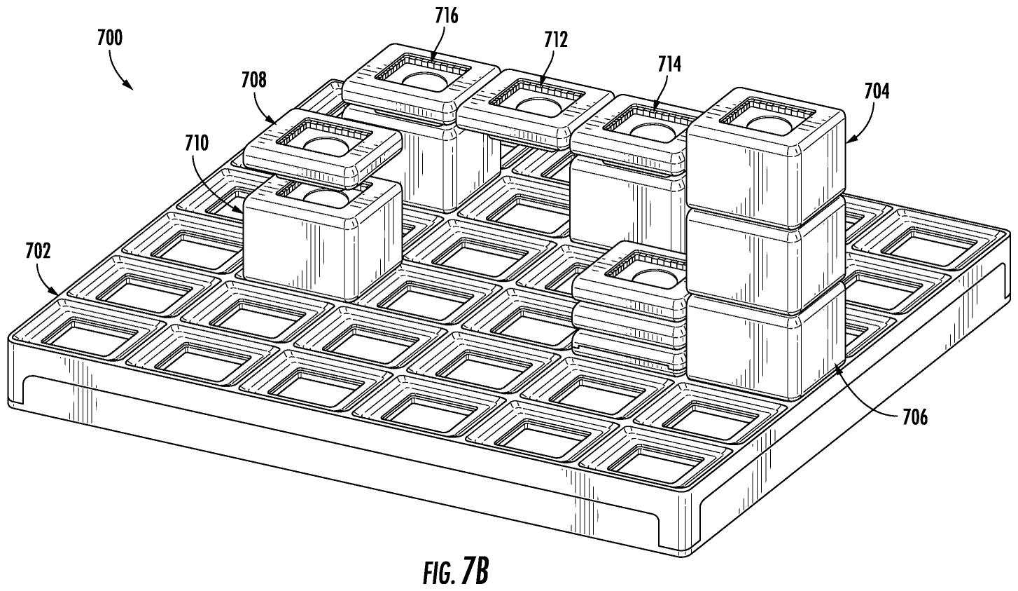

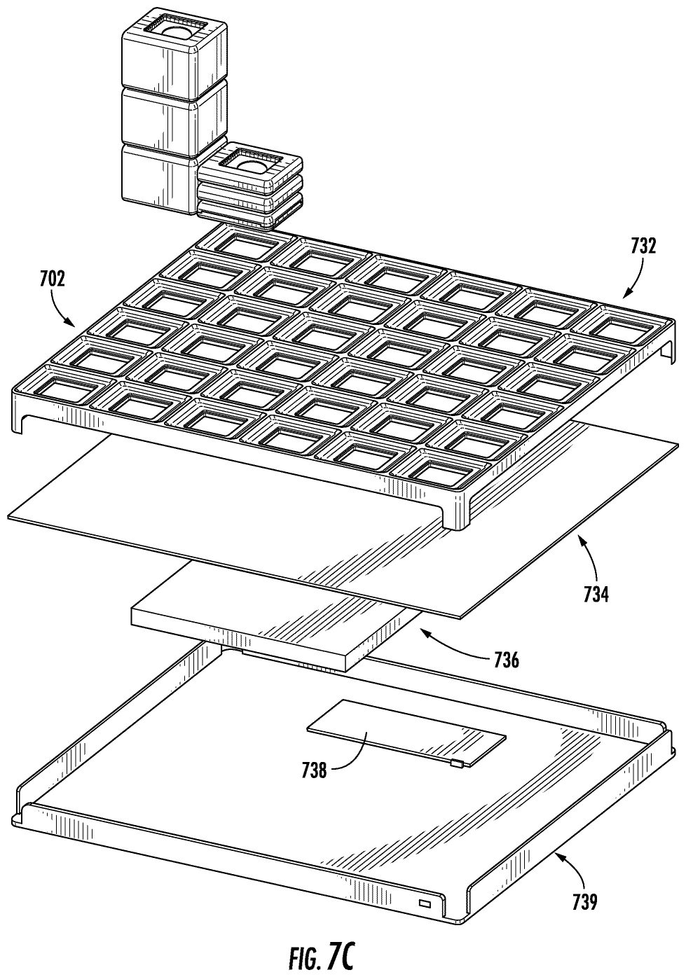

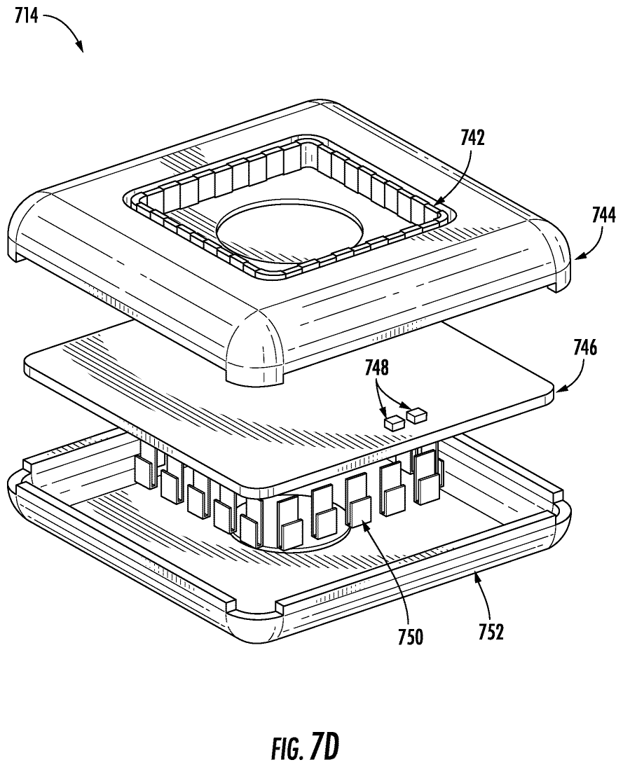

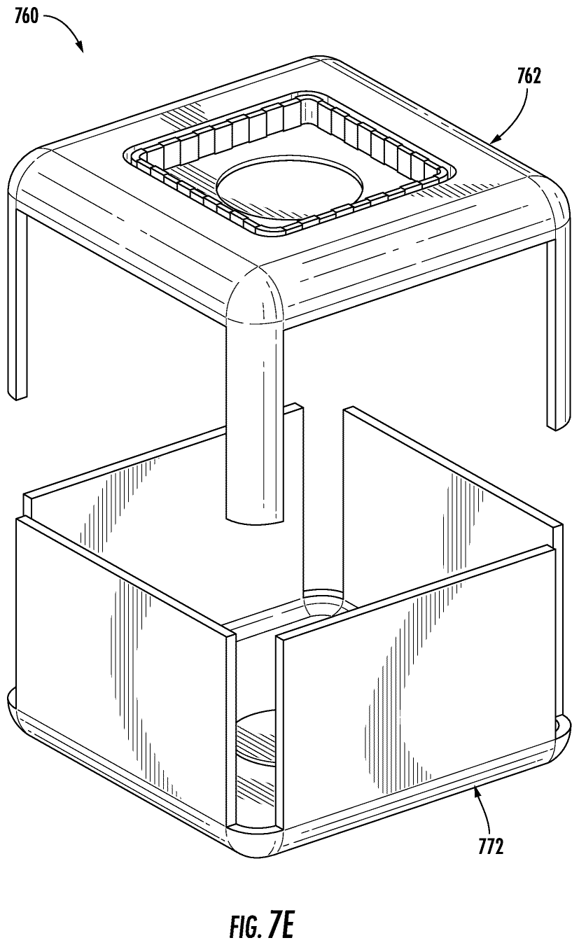

FIGS. 7A-B depict front and rear perspectives of an example block assembly 700 according to example aspects of the present disclosure. As depicted in FIGS. 7A-B, the block assembly 700 includes a plot block 702 and a plurality of physical building blocks (e.g., blocks 704-710) arranged in varying locations. The physical building block 708 is shown in the process of being placed onto the block 710. The physical building block 712 is being held in place by adjoining blocks 714 and 716 (e.g., using magnets or other coupling mechanisms). In some implementations, as illustrated, the plot block 702 can be physically divided into grid squares or other segmented units. The grid squares can be designated with certain names or locations, such as starting with A1 and following a naming convention of: Row=Letter, Column=Number.

FIG. 7C depicts an exploded view of an example plot block 702 according to example aspects of the present disclosure. The example plot block 702 includes a mat upper housing 732, a grid printed circuit board assembly (PCBA) 734, a power source (e.g., battery pack) 736, a communications unit PCBA 738, and a mat lower housing 739. For example, the communications unit PCBA 738 can perform communications according to a number of different communications techniques, including radio-based communications techniques such as Bluetooth.

FIG. 7D depicts an exploded view of an example physical building block 714 according to example aspects of the present disclosure. The physical building block 714 can include a number of fixed contacts 742 arranged within a block upper housing 744. For example, the fixed contacts 742 can be co-molded with the block upper housing 744. As one example, the block upper housing 744 can be made from ABS plastic. The physical building block 714 can also include a block PCBA 743. In one example, the block PCBA 743 can be secured using an interference fit. The block PCBA 743 can include or have located thereon two (or some other number) physical sensors 748 such as, for example, orientation resistors. The physical building block 714 can include a number of flexible contacts 750 and a block lower housing 752. For example, the flexible contacts 750 can be co-molded with the block lower housing 752. As one example, the block lower housing 752 can be made from ABS plastic. In some implementations, one or more magnets (not shown) can be embedded in the block upper housing 744 and/or the block lower housing 752.

FIG. 7E depicts an exploded view of an example physical building block housing 760 according to example aspects of the present disclosure. The block housing 760 can include an upper housing 762 and a lower housing 772. In some implementations, one or more magnets (not shown) can be embedded in the upper housing 762 and/or the lower housing 772. The block housing 760 has different dimensions than the example physical building block 714 shown in FIG. 7D. Therefore, the connection dimensions and orientation can change accordingly.

Referring collectively to FIGS. 7A-E, in some implementations, the system can operate as follows: The plot block 702 can set all grid points to disable block communication by ENABLING an “EN” pin. Next, each grid point will monitor a “Block Detect” pin and an “Orientation” pin. For example, the “Block Detect” pin can receive 3V which can be detected when a physical building block is added. In some implementations, once a block is detected, the grid point will DISABLE the “EN” pin.

Some or all of the physical building blocks can run a block application on the physical building block. As soon as the block application runs it will ENABLE the “EN” pin by default for the block above. If no block is detected, the physical building block can send a single packet to the plot block 702. The packet can provide various information such as Type, Thickness, No Block Detected, etc. If a block is detected, the physical building block can send a single packet to the plot block 702. The packet can provide various information such as Type, Thickness, Block Detected, Orientation of Block Detected, etc. Once the packet is transmitted, the physical building block will sleep. This process continues for each consecutive block placed on each grid point. In some implementations, the orientation of the first block is detected by the plot block 702, and each additional block added has its orientation reported by the block below.

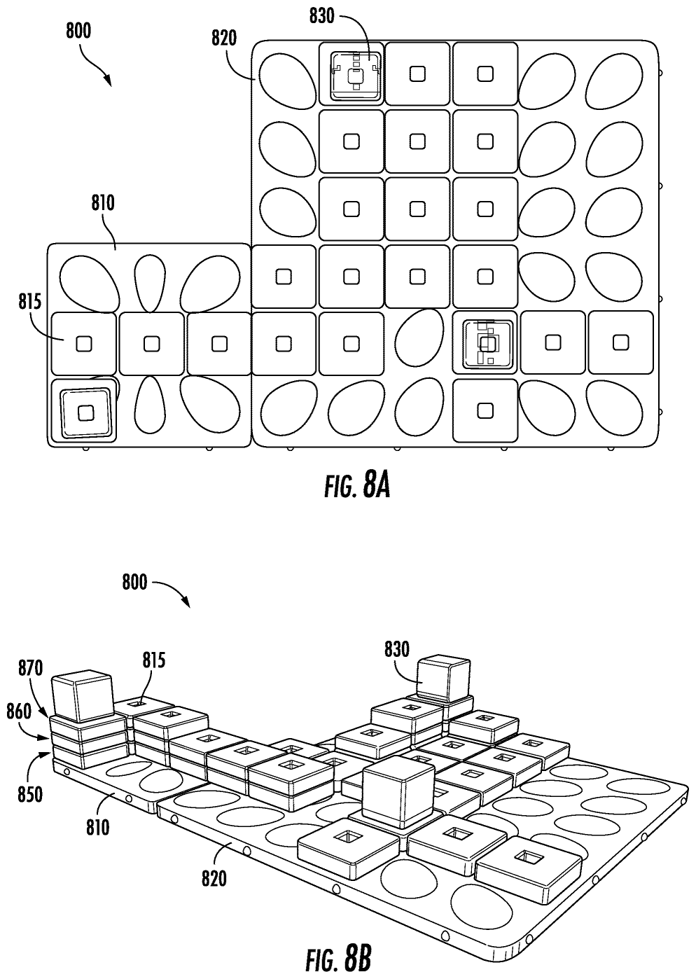

FIG. 8A depicts a top-down view of an example block assembly 800 according to example aspects of the present disclosure. The block assembly 800 includes a first plot block 810 and a second plot block 820. The first plot block 810 is coupled to the second plot block 820. The block assembly 800 includes physical building blocks 815 stacked on the plot blocks 810, 820. Additionally, the block assembly 800 includes creature blocks 830 disposed on the physical building blocks 815.

FIG. 8B depicts a perspective view of an example block assembly 800 according to example aspects of the present disclosure. As illustrated in FIG. 8B, a player can construct a block assembly 800 resembling a scene, level, or area of a gaming environment. For instance, the physical building blocks 815 can be stacked in layers to terraform the region and give shape and/or height variations to the virtual environment. As illustrated, the block assembly 800 has a first layer 850, a second layer 860, and a third layer 870. Additionally and/or alternatively, the player can position creature resources in particular areas of the virtual environment corresponding to the position of the creature blocks 830.

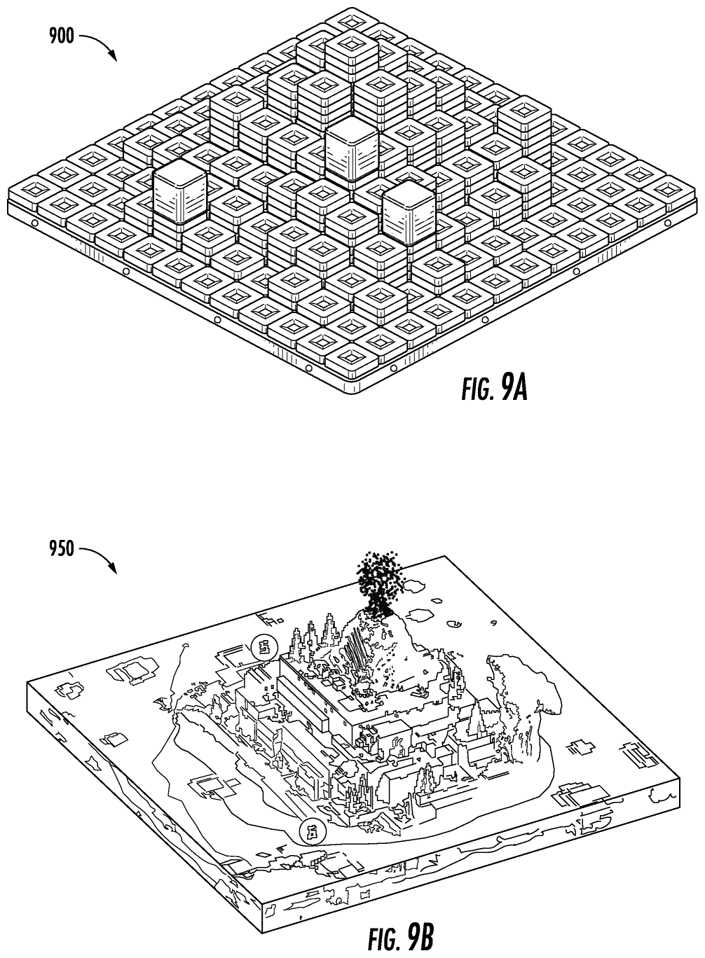

FIG. 9A depicts a block assembly 900 according to example aspects of the present disclosure. FIG. 9B depicts an example virtual environment 950 that can be constructed from the block assembly 900 of FIG. 9A according to example aspects of the present disclosure. For instance, FIGS. 9A and 9B illustrate how block attributes such as color can correspond to aspects of the virtual environment. As one example, the blocks on the single-block-high layers of block assembly 900 can be blue and can correspond to water such that the area is an island. Distinct colors of blocks can also represent different types of ground or rock such as, for example, dirt, grass, and volcanic rock. Creature blocks can also be positioned around the plot block to place corresponding creature resources in the virtual structure.

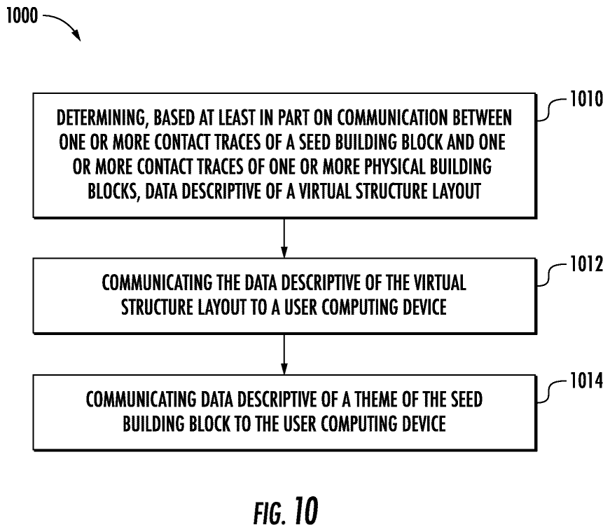

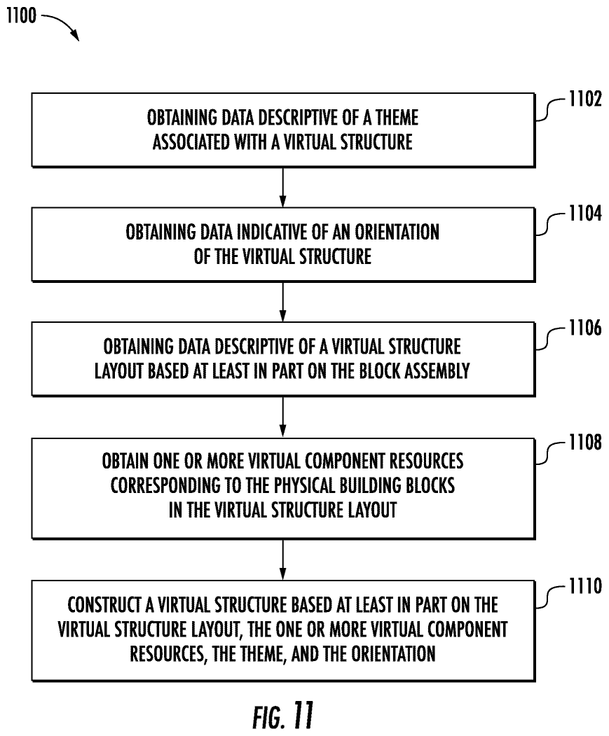

FIG. 10 depicts a flow chart diagram of an example method 1000 for communicating data from a seed building block according to example embodiments of the present disclosure. Although FIG. 10 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

The method 1000 can include, at 1010, determining, based at least in part on communication between the one or more contact traces of a seed building block and one or more contact traces of one or more physical building blocks, data descriptive of a virtual structure layout. The virtual structure layout can be descriptive of at least one of a relative positioning, orientation, or one or more attributes of the one or more physical building blocks. For example, an internal computing module of the seed building block can communicate, via the one or more contact traces, with internal computing modules (e.g., computer-readable memory) of the physical building blocks. The internal computing module can read block attributes and/or determine arrangement of the physical building blocks that are coupled in a block assembly with the seed building block.

The virtual structure layout can be or can include data descriptive of an arrangement of a seed building block and one or more physical building blocks. For instance, the virtual structure layout can be a schematic or arrangement of a virtual structure to be rendered by a gaming application. The virtual structure layout can be descriptive of at least one of a relative positioning, orientation, or one or more attributes of the assembly of physical building blocks. Additionally and/or alternatively, in some implementations, the virtual structure layout can include the data indicative of the theme of the seed building block.

In some implementations, the computing system can be configured to determine an assembly orientation of the block assembly of physical building blocks. For instance, in some implementations, the seed building block (e.g., an internal computing module of the seed building block) can determine the assembly orientation of the block assembly. The assembly orientation of the block assembly can be used in determining the orientation of the virtual structure layout. For instance, the assembly orientation can be defined relative to a “ground” plane, a coordinate grid (e.g., a three-dimensional coordinate grid), and/or any other suitable reference. The virtual structure can then be oriented such that the direction of the reference of the assembly orientation corresponds to a direction of virtual ground or other suitable virtual reference.

The method 1000 can include, at 1012, communicating the data descriptive of the virtual structure layout to a user computing device. The user computing device can be configured to construct a virtual structure based at least in part on the data descriptive of the virtual structure layout. As one example, the internal computing module of the seed building block can communicate the data descriptive of the virtual structure layout to a gaming application on the user computing device. The user computing device can be configured to construct a virtual structure based at least in part on the data descriptive of the virtual structure layout. For instance, a gaming application on the user computing device can construct and/or render the virtual structure.

In some implementations, the method 1000 can include, at 1014, communicating, by a computing system, data descriptive of a theme of the virtual structure. As an example, a seed building block (e.g., an internal computing module of the seed building block) can communicate the data descriptive of theme of the virtual structure to a gaming application. For instance, in some implementations, data descriptive of the theme of the virtual structure can be stored by non-transitory, computer-readable media of the seed building block (e.g., the internal computing module of the seed building block). As another example, in some implementations, the theme of the virtual structure can be determined based at least in part on one or more attributes of the seed building block, such as an identifier of the seed building block, serial number of the seed building block, model number of the seed building block, etc. The systems and methods according to example aspects of the present disclosure can include receiving, by a computing system (e.g., by a gaming application on a user computing device), data descriptive of a theme associated with the virtual structure. The data descriptive of the theme can be, for example, a theme identifier.

FIG. 11 depicts a flow chart diagram of an example method 1100 for constructing a virtual structure based at least in part on a block assembly according to example embodiments of the present disclosure. Although FIG. 11 depicts steps performed in a particular order for purposes of illustration and discussion, the methods of the present disclosure are not limited to the particularly illustrated order or arrangement. The various steps of the method 1100 can be omitted, rearranged, combined, and/or adapted in various ways without deviating from the scope of the present disclosure.

A player can arrange one or more physical building blocks to form a block assembly of one or more physical building blocks. For instance, the player can couple the coupling systems of each of the one or more physical building blocks together such that the physical building blocks are arranged into the block assembly. Additionally and/or alternatively, the contact traces of (e.g., adjacent) physical building blocks in the block assembly can be placed into contact to form electrically conductive paths through at least a portion of the block assembly. The block assembly can include at least one seed building block. Additionally and/or alternatively, the blocks in the block assembly can be placed into wireless communications with one another.

The method 1100 can include, at 1102, receiving, by a computing system (e.g., by a gaming application on a user computing device), data descriptive of a theme associated with a virtual structure. The data descriptive of the theme can be, for example, a theme identifier. As an example, a seed building block (e.g., an internal computing module of the seed building block) can communicate the data descriptive of theme of the virtual structure to a gaming application. For instance, in some implementations, data descriptive of the theme of the virtual structure can be stored by non-transitory, computer-readable media of the seed building block (e.g., the internal computing module of the seed building block). As another example, in some implementations, the theme of the virtual structure can be determined based at least in part on one or more attributes of the seed building block, such as an identifier of the seed building block, serial number of the seed building block, model number of the seed building block, etc.

The method 1100 can include, at 1104, obtaining, by a computing system (e.g., by a gaming application on a user computing device), data indicative of an orientation of the virtual structure. For instance, in some implementations, the computing system can be configured to determine an assembly orientation of the block assembly of physical building blocks. For instance, in some implementations, the seed building block (e.g., an internal computing module of the seed building block) can determine the assembly orientation of the block assembly. The assembly orientation of the block assembly can be used in determining the orientation of the virtual structure. For instance, the assembly orientation can be defined relative to a “ground” plane, a coordinate grid (e.g., a three-dimensional coordinate grid), and/or any other suitable reference. The virtual structure can then be oriented such that the direction of the reference of the assembly orientation corresponds to a direction of virtual ground or other suitable virtual reference.

For example, in some implementations, the seed building block can be a plot block having a length and a width. The orientation of the virtual structure can be defined such that the plot block acts as the ground plane (e.g., the length and width are in the direction of the ground plane). As another example, in some implementations, the seed building block and/or another physical building block can include an orientation module. The orientation module can be or can include any suitable device for determining orientation of the seed building block and/or other physical building block(s) such as, for example, a gyroscope. The orientation module can determine how the assembly is oriented relative to a reference such as, for example, earth gravity.

The method 1100 can include, at 1106, obtaining data descriptive of a virtual structure layout based at least in part on the block assembly. The virtual structure layout can be or can include data descriptive of an arrangement of a seed building block and one or more physical building blocks. For instance, the virtual structure layout can be a schematic or arrangement of a virtual structure to be rendered by a gaming application. The virtual structure layout can be descriptive of at least one of a relative positioning, orientation, or one or more attributes of the assembly of physical building blocks. Additionally and/or alternatively, in some implementations, the virtual structure layout can include the data indicative of the theme of the seed building block.

Systems and methods according to example aspects of the present disclosure can be configured to communicate the data descriptive of the virtual structure layout to a user computing device. As one example, the internal computing module of the seed building block can communicate the data descriptive of the virtual structure layout to a gaming application on the user computing device. The user computing device can be configured to construct a virtual structure based at least in part on the data descriptive of the virtual structure layout. For instance, a gaming application on the user computing device can construct and/or render the virtual structure.

The method 1100 can include, at 1108, obtaining one or more virtual structure component resources. The one or more virtual structure component resources can be associated with virtual representations based at least in part on the physical building blocks. For instance, in some cases, the one or more virtual structure component resources can correspond to physical building blocks in the virtual structure layout. As one example, the one or more virtual structure component resources can be associated with a same shape, size, type, or other characteristics as corresponding physical building blocks. For instance, the virtual structure component resources can have an appearance that is similar to an appearance of a corresponding physical building block. In some implementations, the virtual structure component resources can be digital resources, such as, for example, virtual models of or resembling the physical building blocks.

The method 1100 can include, at 1110, constructing a virtual structure. Based at least in part on the data descriptive of the virtual structure layout, the assembly orientation, the theme, the one or more virtual structure component resources, and/or other data descriptive of the block assembly, the computing system can construct a virtual structure corresponding to the block assembly. For example, the computing system can arrange the virtual structure component resources as illustrated by the virtual structure layout such that the layout of the virtual structure component resources in the virtual structure corresponds to the layout of the physical building blocks in the block assembly.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1.-25. (canceled)

26. A computer-implemented method for performing a trade of digital resources in a game via interactions with physical blocks, the method comprising:
receiving, by a server-side gaming application of a server computing system and from a first gaming application of a first user computing device, a first identifier that identifies a first digital resource associated with a first physical block associated with the game;
wherein the first user computing device obtained the first identifier from a first computer-readable media contained in the first physical block; and
wherein the first digital resource is associated with a first player account;
receiving, by the server-side gaming application of the server computing system and from a second gaming application of a second user computing device, a second identifier that identifies a second digital resource associated with a second physical block associated with the game;
wherein the second user computing device obtained the second identifier from a second computer-readable media contained in the second physical block; and
wherein the second digital resource is associated with a second player account;
causing, by the server-side gaming application of the server computing system, the first digital resource to be associated with the second player account; and
causing, by the server-side gaming application of the server computing system, the second digital resource to be associated with the first player account.

27. The computer-implemented method of claim 26, wherein:
the first computer-readable media contained in the first physical block contains a first NFC tag and the first user computing device comprises a first NFC reader that reads the first identifier from the first NFC tag; and
the second computer-readable media contained in the second physical block contains a second NFC tag and the second user computing device comprises a second NFC reader that reads the second identifier from the second NFC tag.

28. The computer-implemented method of claim 26, wherein:
the first digital resource comprises a first virtual creature; and
the second digital resource comprises a second virtual creature.

29. The computer-implemented method of claim 28, wherein the first virtual creature and the second virtual creature have been procedurally generated.

30. The computer-implemented method of claim 26, further comprising, in response to the trade:
assigning, by the server-side gaming application of the server computing system, one or more experience points or other virtual rewards to one or both of the first player account and the second player account.

31. The computer-implemented method of claim 26, further comprising:
continuing to assign, by the server-side gaming application of the server computing system, one or more experience points or other virtual rewards to the first player account in response to future interactions associated with the first digital creature that occur after the trade.

32. The computer-implemented method of claim 26, wherein one or both of the first physical block and the second physical block are rectangular.

33. A computer-implemented method for performing a mutation of digital resources in a game via interactions with physical blocks, the method comprising:
receiving, by a server-side gaming application of a server computing system and from a first gaming application of a first user computing device, a first identifier that identifies a first digital resource associated with a first physical block associated with the game;
wherein the first user computing device obtained the first identifier from a first computer-readable media contained in the first physical block;
wherein the first digital resource comprises first genetic values for one or more characteristics; and
receiving, by the server-side gaming application of the server computing system and from a second gaming application of a second user computing device, a second identifier that identifies a second digital resource associated with a second physical block associated with the game;
wherein the second user computing device obtained the second identifier from a second computer-readable media contained in the second physical block;
wherein the second digital resource comprises second genetic values for the one or more characteristics; and
mutating, by the server-side gaming application of the server computing system, the first genetic values of the first digital resource based on the second genetic values of the second digital resource; and
mutating, by the server-side gaming application of the server computing system, the second genetic values of the second digital resource based on the first genetic values of the first digital resource.

34. The computer-implemented method of claim 33, wherein:
the first computer-readable media contained in the first physical block contains a first NFC tag and the first user computing device comprises a first NFC reader that reads the first identifier from the first NFC tag; and
the second computer-readable media contained in the second physical block contains a second NFC tag and the second user computing device comprises a second NFC reader that reads the second identifier from the second NFC tag.

35. The computer-implemented method of claim 33, wherein:
the first digital resource comprises a first virtual creature; and
the second digital resource comprises a second virtual creature.

36. The computer-implemented method of claim 35, wherein the first virtual creature and the second virtual creature have been procedurally generated.

37. The computer-implemented method of claim 33, wherein mutating, by the server-side gaming application of the server computing system, the first genetic values of the first digital resource based on the second genetic values of the second digital resource comprises randomly selecting, for the first digital resource and for each of the one or more characteristics, one of the first genetic values or the second genetic values.

38. The computer-implemented method of claim 26, further comprising:
continuing to assign, by the server-side gaming application of the server computing system, one or more experience points or other virtual rewards to a first player account associated with the first user device in response to future interactions associated with the second digital creature that occur after the mutation.

39. The computer-implemented method of claim 26, wherein one or both of the first physical block and the second physical block are rectangular.

40. The computer-implemented method of claim 33, further comprising minting a non-fungible token that corresponds to the first genetic values of the first digital resource after the mutation.

41. A computing system comprising a gaming application configured to enable trading or mutation of digital resources in a game, the computing system comprising:
one or more processors; and
one or more non-transitory computer-readable media that store the gaming application configured to perform operations, the operations comprising:
receiving a first identifier that identifies a first digital resource associated with a first physical block associated with the game;
wherein the first identifier was obtained from a first computer-readable media contained in the first physical block; and
receiving a second identifier that identifies a second digital resource associated with a second physical block associated with the game;
wherein the second identifier was obtained from a second computer-readable media contained in the second physical block; and
performing one or both of:
a trade of the first digital resource and the second digital resource between two player accounts; and
a mutation of genetic values of at least one of the first digital resource and the second digital resource based on genetic values of the other of the first digital resource and the second digital resource.
